(19) United States
(12) Patent Application Publication
(10) Pub. No.: US 2026/0331012 A1
(43) Pub. Date: Oct. 22, 2026

(54) METHOD FOR PROVIDING PROJECTION SCREEN AND ELECTRONIC RING DEVICE PERFORMING METHOD

(71) Applicant: Samsung Electronics Co., Ltd., Suwon-si (KR)

(72) Inventor: Youngjae MEEN, Suwon-si (KR)

(21) Appl. No.: 19/706,236

(22) Filed: Jun. 12, 2026

Related U.S. Application Data
(63) Continuation of application No. PCT/KR2025/001115, filed on Jan. 21, 2025.

(30) Foreign Application Priority Data
Jan. 30, 2024 (KR) 10-2024-0014327
Mar. 18, 2024 (KR) 10-2024-0037401

(51) Int. Cl. G09G 3/00; G06F 3/01; G06T 7/20

(52) U.S. Cl. CPC G09G 3/001; G06F 3/014; G06T 7/20; G06T 2207/30196; G09G 2340/0464; G09G 2340/0492; G09G 2354/00

(57) ABSTRACT

A first electronic ring device includes: a camera; sensor circuitry; projection circuitry; at least one processor; and a memory storing instructions, wherein the instructions, when executed by at least one processor, may cause the first electronic ring device to: identify that the first electronic ring device is worn on a user's finger; control the projection circuitry to output a first projection screen on the surface of the user; and based on a motion of the user detected while the first projection screen is output, control the projection circuitry to adjust a length of at least one of a left side, a right side, a near side, and/or a far side of the first projection screen, the position of the first projection screen, and/or the rotation angle of the first projection screen.

### CROSS-REFERENCE TO RELATED APPLICATIONS

This application is a continuation of International Application No. PCT/KR2025/001115 designating the United States, filed on Jan. 21, 2025, in the Korean Ministry of Intellectual Property Receiving Office and claiming priority to Korean Patent Application Nos. 10-2024-0014327, filed on Jan. 30, 2024, and 10-2024-0037401, filed on Mar. 18, 2024, in the Korean Ministry of Intellectual Property, the disclosures of each of which are incorporated by reference herein in their entireties.

### BACKGROUND

### Field

The disclosure relates to a method and apparatus providing a projection screen using one or more ring electronic devices.

### Description of Related Art

A ring-type wearable electronic device (hereinafter, a “ring electronic device”) is an electronic device worn on a part of the body (e.g., a finger) of a user to perform various functions. The ring electronic device may monitor the health condition (e.g., heart rate, sleep patterns, activity levels, and/or stress levels) of the user using at least one sensor. The ring electronic device may track the activity information (e.g., position, posture, and/or movements) of the user. The ring electronic device may operate in conjunction with other electronic devices to provide the user with notifications (e.g., calls, text messages, and/or emails) from those electronic devices.

The above information may be presented as the related art to help with the understanding of the disclosure. No assertion or determination is made as to whether any of the above description is applicable as the prior art related to the present disclosure.

### SUMMARY

According to an example embodiment, a first ring electronic device includes: a camera, sensor circuitry, projection circuitry, at least one processor including processing circuitry, and memory including one or more storage media storing instructions, wherein the instructions, when executed by at least one processor, individually or in any combination, may cause the first ring electronic device to: based on data received from the sensor circuitry, identify that the first ring electronic device is worn on a finger of a user, control the projection circuitry to output a first projection screen on a surface of the user while the first ring electronic device is worn on the finger of the user, wherein the first projection screen has a left side, a right side, a near side, and a far side, and based on a motion of the user detected while the first projection screen is output, control the projection circuitry to adjust at least one of a length of at least one of the left side, the right side, the near side, or the far side, a position of the first projection screen, and/or a rotation angle of the first projection screen.

According to an example embodiment, a first ring electronic device includes: a camera, sensor circuitry, projection circuitry, at least one processor including processing circuitry, and memory including one or more storage medium storing instructions, wherein the instructions, when executed by at least one processor individually or in any combination, may cause the first ring electronic device to: based on data received from the sensor circuitry, identify that the first ring electronic device is worn on a finger of a user, based on detecting at least a part of a first trigger motion for a projection screen using data received from the camera while the first ring electronic device is worn on the finger of the user, control the projection circuitry to output a first projection screen on a surface of the user, wherein the first projection screen has a left side, a right side, a near side, and a far side, wherein a second projection screen is output on the surface of the user by a second ring electronic device worn on another finger different from the finger of the user, and while the first projection screen and the second projection screen are output, based on detecting at least a part of a second trigger motion for a unified projection screen of the first ring electronic device and the second ring electronic device or at least a part of a third trigger motion for expanding a user interface using the data received from the camera, control the projection circuitry to output a first part as the projection screen, wherein the first part is a part of a screen for an expanded user interface corresponding to content of the first ring electronic device and/or content of an external electronic device connected to the first ring electronic device.

According to an example embodiment, a method performed by a first ring electronic device, wherein the first ring electronic device includes a camera, sensor circuitry, projection circuitry, at least one processor including processing circuitry, and memory including one or more storage media storing instructions, and the instructions, when executed by at least one processor individually or in any combination, cause the first ring electronic device to perform the method comprising: based on data received from the sensor circuitry, identify that the first ring electronic device is worn on a finger of a user, control the projection circuitry to output a first projection screen on a surface of the user while the first ring electronic device is worn on the finger of the user, wherein the first projection screen has a left side, a right side, a near side, and a far side, and based on a motion of the user detected while the first projection screen is output, control the projection circuitry to adjust at least one of a length of at least one of the left side, the right side, the near side, and/or the far side, a position of the first projection screen, or a rotation angle of the first projection screen.

### BRIEF DESCRIPTION OF THE DRAWINGS

The above and other aspects, features and advantages of certain embodiments of the present disclosure will be more apparent from the following detailed description, taken on conjunction with the accompanying drawings, in which:

FIG. 1 is a block diagram illustrating an example electronic device in a network environment, according to various example embodiments.

FIG. 2 is a diagram illustrating an example configuration of a ring electronic device according to various example embodiments.

FIG. 3 is a flowchart illustrating an example method of providing a projection screen according to various example embodiments.

FIG. 4 is a diagram illustrating an example operation of providing a projection screen according to various example embodiments.

FIGS. 5A, 5B, and 5C are signal flow diagrams illustrating an example method of providing a unified projection screen according to various example embodiments.

FIG. 6 is a diagram illustrating an example operation of providing a unified projection screen according to various example embodiments.

FIG. 7 is a diagram illustrating an example operation of providing a split screen according to various example embodiments.

FIG. 8 is a flowchart illustrating an example method of providing a unified projection screen according to various example embodiments.

FIG. 9 is a diagram illustrating an example method of adjusting a screen according to various example embodiments.

FIG. 10 is a diagram illustrating an example operation of aligning projection screens according to various example embodiments.

FIGS. 11A and 11B are diagrams illustrating an example operation of adjusting output of a projection screen according to various example embodiments.

FIG. 12 is a diagram illustrating an example operation of stopping outputting a projection screen according to various example embodiments.

FIG. 13 is a diagram illustrating an example operation associated with an external electronic device according to various example embodiments.

FIG. 14 is a diagram illustrating an example user interface corresponding to a task associated with a ring electronic device, according to various example embodiments.

FIG. 15 is a diagram illustrating an example operation of providing a projection screen according to various example embodiments.

FIG. 16 is a diagram illustrating an example system including a ring electronic device, according to various example embodiments.

### DETAILED DESCRIPTION

Hereinafter, various example embodiments may be described in greater detail with reference to the attached drawings.

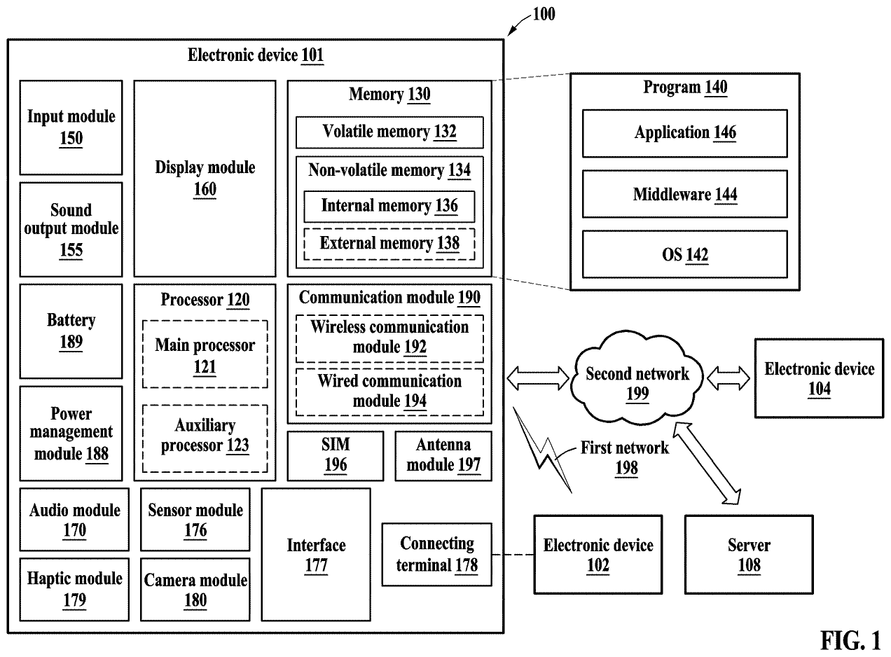

FIG. 1 is a block diagram illustrating an example electronic device in a network environment according to various example embodiments.

Referring to FIG. 1, an electronic device 101 in a network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added to the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively (e.g., in any combination) in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the NPU) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a conventional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., the electronic device 102) (e.g., a speaker or headphones) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a PCB, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or MEC. In an embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

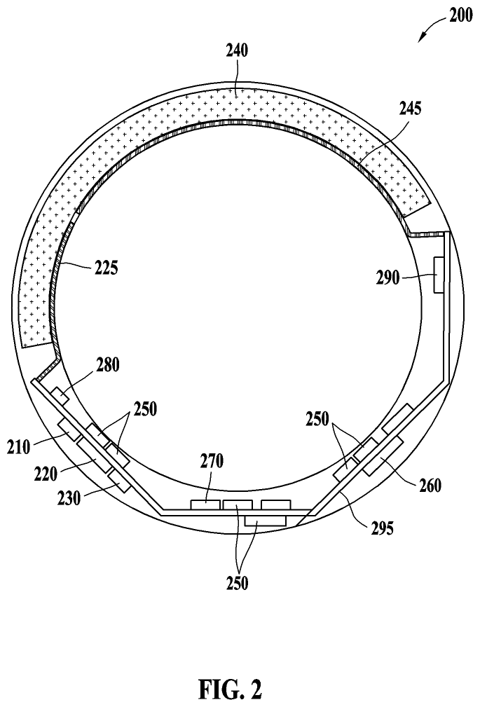

FIG. 2 is a diagram illustrating an example configuration of a ring electronic device according to various example embodiments.

FIG. 2 illustrates a cross-sectional view of a ring electronic device 200 (e.g., the electronic device 102 of FIG. 1) according to an embodiment. The ring electronic device 200 may support biometric information sensing, touch, wireless communication, and screen projection functions and may be an electronic device that may be worn on the body of a user. The ring electronic device 200 may interoperate with another electronic device (e.g., the electronic device 101 of FIG. 1) of the user.

For reference, from the perspective of the ring electronic device 200, an electronic device (e.g., the electronic device 101 of FIG. 1) may be referred to as another electronic device of the user or an external electronic device, and from the perspective of the electronic device (e.g., the electronic device 101 of FIG. 1), the ring electronic device 200 may be referred to as another electronic device of the user or an external electronic device.

In FIG. 2, the ring electronic device 200 is illustrated as a ring type (e.g., a smart ring) that is worn on a finger of the user, but is not limited thereto, and may be implemented as other types of accessory electronic devices such as a watch type (e.g., a smart watch) or a band type (e.g., a smart band).

According to an embodiment, the ring electronic device 200 may include a housing that may be worn on a finger of the user. For example, the housing of the ring electronic device 200 may include a first housing (e.g., an outer ring housing, a first ring housing, or a first housing part) and a second housing (e.g., an inner ring housing, a second ring housing, or a second housing part) coupled to the first housing and including an opening, wherein both the first and second housings are annular. The opening may be formed to a size that accommodates a finger of the user. At least a part of the second housing may be in contact with the body (e.g., a finger) of the user when the ring electronic device 200 is worn on the body (e.g., the finger) of the user. In various embodiments of the present disclosure, the ring electronic device 200 being worn on a predetermined hand of the user may indicate that the ring electronic device 200 is worn on one of the fingers of that predetermined hand.

For example, the first housing may be formed of a material that withstands external impact or scratches, such as a metal material (e.g., titanium), ceramic, or stainless steel. A separate fixing or coating process for color implementation may be performed on the first housing. The second housing may be formed of the same material as the first housing or may be formed of a material such as a molding material for sensing, plastic, or glass. The second housing may be formed such that a material for sensing (e.g., a metallic material for biometric measurement, a molding material, transparent plastic, or glass) is formed in at least a part of the second housing.

According to an embodiment, the ring electronic device 200 may include at least one processor (hereinafter, a processor, e.g., including processing circuitry) 210 including processing circuitry, memory (hereinafter, memory) 220 including one or more storage media storing instructions, a communicator (e.g., including communication circuitry) 230, an antenna 225, a battery 240, a charging interface 245, at least one recognition sensor 250, a touch sensor 260, an inertial sensor 270, a temperature sensor 280, a PMIC (e.g., including power management circuitry) 290, sensor circuitry, a camera, and a projection circuitry.

According to an embodiment, the processor 210 may perform operations or data processing regarding the control and/or communication of respective components of the ring electronic device 200. The processor 210 may store instructions or data received from other components (e.g., the communicator 230, a biometric sensor 250, the touch sensor 260, the inertial sensor 270, the temperature sensor 280, the sensor circuitry, the camera, and the projection circuitry) in the memory 220, process the instructions or data stored in the memory 220, and store result data in the memory 220. According to an embodiment, the processor 210 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently from, or in conjunction with, the main processor. The processor 210 may be implemented in an integrated form with other components (e.g., the communicator 230, the biometric sensor 250, the touch sensor 260, the inertial sensor 270, the temperature sensor 280, the sensor circuitry, the camera, and the projection circuitry). A detailed description of the processor 120 above applies equally to the processor 210 here, and as such the detailed description may not be repeated here.

There are no limitations on operational and data processing functions that the processor 210 may implement on the ring electronic device 200, but in this disclosure, the processor 210 may process various operations to mainly support a payment function by interoperating with another electronic device (e.g., the electronic device 101 of FIG. 1) of the user.

According to an embodiment, the memory 220 may store a variety of data used by at least one component (e.g., the processor 210, the biometric sensor 250, the touch sensor 260, the inertial sensor 270, the temperature sensor 280, the sensor circuitry, the camera, and the projection circuitry) of the ring electronic device 200. For example, data may include software (e.g., a program) including various instructions that may be executed by the processor 210. The software may include control instructions, such as arithmetic and logical operations, data movement, or input/output, which may be recognized by the processor 210. For example, the data may include input data or output data for instructions associated with the software.

The communicator 230 according to an embodiment may include various hardware including various communication circuitry and/or software configurations to support wireless communication with an external electronic device that includes at least some components of the electronic device 101 of FIG. 1 or the ring electronic device 200. For example, the communicator 230 may support communication between a plurality of ring electronic devices (e.g., a first ring electronic device and a second ring electronic device) that includes at least some of the components of the ring electronic device 200. The ring electronic device 200 may transmit and receive a variety of data or control commands to and from an external electronic device by wire or wirelessly via the communicator 230. In an embodiment, a communication module may support short-range wireless communication. Near-field wireless communication may include at least one of Bluetooth, Bluetooth low energy (BLE), ZigBee, ANT+, wireless-fidelity (Wi-Fi), cellular (e.g., long term evolution (LTE), fifth generation (5G), sixth generation (6G), narrowband Internet of Things (NB-IoT)), near field communication (NFC), radio frequency identification (RFID), ultra-wide band (UWB), global navigation satellite system (GNSS), and/or magnetic secure transmission (MST). However, the disclosure is not limited thereto. According to an embodiment, the communicator 230 may be implemented independently of the processor 210 and/or integrated with the processor 210.

The antenna 225 according to an embodiment may be connected to the communicator 230 through a substrate 295. The ring electronic device 200 may transmit or receive a communication signal and/or data to or from the outside (e.g., an external electronic device) through the antenna 225. The antenna 225 may include a single antenna or a plurality of antennas. In various embodiments, a part (e.g., a metal member) of the first housing may be designed to be used as the antenna 225.

The battery 240 according to an embodiment may store energy for supplying power to the ring electronic device 200. The battery 240 may be charged and discharged and may be formed of various materials (e.g., lithium-ion, mercury, or a dry cell). The battery 240 may include a flexible battery pack to be disposed within the ring electronic device 200. For example, the battery 240 may be formed in a curved shape having a curvature corresponding to the curvature formed by the space between the first housing and the second housing. According to an embodiment, the battery 240 may include a plurality of battery packs arranged separately. The battery 240 may be connected to the charging interface 245.

The charging interface 245 may include various circuitry and support various charging techniques of the ring electronic device 200. For example, the charging interface 245 may support wired charging (e.g., a connector) or wireless charging (e.g., Wireless Power Consortium (WPC) or NFC) for charging. The charging interface 245 according to an embodiment may be electrically connected to the PMIC 290 mounted on the substrate 295 through the substrate 295.

The PMIC 290 may include various power management circuitry and manage power for the ring electronic device 200. The PMIC 290 according to an embodiment may manage power transferred from the battery 240 to each component of the ring electronic device 200. For example, the PMIC 290 may appropriately distribute power to the components (e.g., at least one of the processor 210, the memory 220, the communicator 230, the battery 240, the biometric sensor 250, the touch sensor 260, the inertial sensor 270, the temperature sensor 280, the sensor circuitry, the camera, or the projection circuitry) of the ring electronic device 200.

Using an optical signal, at least one biometric sensor 250 may obtain a variety of biometric information of the user. For example, the biometric sensor 250 may be a photoplethysmogram (PPG) sensor or an optical sensor capable of obtaining a variety of biometric information such as heart rate (HR) and blood circulation by measuring a pulse wave (plethysmogram) according to the optical signal. However, the disclosure is not limited thereto. The biometric sensor 250 may obtain biometric information such as HR, blood pressure, saturation of percutaneous oxygen (SpO2), galvanic skin response (GSR), electrocardiography (ECG), blood flow velocity, or bioelectrical impedance. However, the disclosure is not limited thereto.

The biometric sensor 250 according to an embodiment may include a fingerprint sensor.

The touch sensor 260 may sense (e.g., detect) a touch input of the user touching the ring electronic device 200. The touch sensor 260 may be implemented using at least one of, for example, a resistive, capacitive, optical, or ultrasonic technique. According to various embodiments, the touch sensor 260 may be omitted.

The inertial sensor 270 may sense the inertia of the ring electronic device 200. The inertial sensor 270 may obtain motion information of the ring electronic device 200. For example, the inertial sensor 270 may sense a motion, gesture, impact, posture and/or activity (e.g., sedentary, moving, or sports). The inertial sensor 270 may include an acceleration sensor and/or a gyroscope sensor. For example, the inertial sensor 270 may include a three-axis acceleration sensor and may be implemented as a three-axis sensor. For example, the inertial sensor 270 may include a three-axis acceleration sensor and a three-axis gyroscope sensor and may be implemented as a six-axis sensor. The inertial sensor 270 may monitor shaking information of the ring electronic device 200. The ring electronic device 200 may include a position measurement circuit (e.g., a global positioning system (GPS) circuit) (or a GPS sensor). Through the position measurement circuit (e.g., a GPS circuit) (or a GPS sensor), the ring electronic device 200 may obtain position information thereof.

The temperature sensor 280 according to an embodiment may be a sensor that measures the temperature of a living body (e.g., the body temperature of the user) or the temperature of a component (e.g., an electronic component) included in the ring electronic device 200. The temperature sensor 280 may be formed in a contact or non-contact manner and may vary depending on the design. The ring electronic device 200 may store, in the memory 220, temperature information recorded through the temperature sensor 280. The ring electronic device 200 may determine (e.g., measure or estimate) the temperature of a living body (e.g., the body temperature of the user or the skin temperature of the user) based on a measured temperature value under the control of the processor 210. The ring electronic device 200 may use temperature information obtained through the temperature sensor 280 to estimate situation awareness.

According to an embodiment, the ring electronic device 200 may include sensor circuitry that detects the body (e.g., a finger) of the user. Using the sensor circuitry, the ring electronic device 200 may detect the state in which the ring electronic device 200 is worn on the body of the user. Based on data received from the sensor circuitry, the ring electronic device 200 (particularly, the processor 210) may identify the state in which the ring electronic device 200 is worn on the body of the user. In an embodiment, the sensor circuitry may be the biometric sensor 250. Using the sensor circuitry, the ring electronic device 200 may detect a state in which the ring electronic device 200 is worn on a finger of the user by obtaining biometric information such as HR. Using the sensor circuitry, based on whether reflected light corresponding to emitted light is received, the ring electronic device 200 may also detect a state in which the ring electronic device 200 is worn on a finger of the user. In an embodiment, the sensor circuitry may be the inertial sensor 270. Using the sensor circuitry including an acceleration sensor and/or a gyroscope sensor, the ring electronic device 200 may detect a state in which the ring electronic device 200 is worn on a finger of the user.

The sensor circuitry may include at least some of the types of the biometric sensor 250 or the inertial sensor 270 described above or may perform at least some of the functions of the biometric sensor 250 or the inertial sensor 270. However, the disclosure is not limited thereto. For example, the sensor circuitry may include any combination of any of the aforementioned sensors (e.g., the biometric sensor 250, the touch sensor 260, the inertial sensor 270, and the temperature sensor 280) or may be a separate wearing-state detection sensor configured to detect a state in which a ring electronic device is worn on a finger of the user.

According to an embodiment, at least one of the processor 210, the memory 220, the communicator 230, the antenna 235, a flexible printed circuit board (FPCB) substrate, the battery 240, the charging interface 245, at least one biometric sensor 250, the touch sensor 260, the inertial sensor 270, the temperature sensor 280, the PMIC 290, the sensor circuitry, the camera, and the projection circuitry of the ring electronic device 200 may be disposed in the space between the first housing and the second housing. According to an embodiment, some components may be disposed on the substrate 295 (e.g., an FPCB) that has flexibility to correspond to the curvature of the ring electronic device 200. According to an embodiment, some components (e.g., at least one of the sensor circuitry, the camera, and the projection circuitry) or parts of the components may be disposed to be exposed to the outside of the ring electronic device 200.

According to an embodiment, the substrate 295 may be a flexible electrical circuit substrate. Various components (e.g., at least one of the processor 210, the memory 220, the communicator 230, the battery 240, the biometric sensor 250, the touch sensor 260, the inertial sensor 270, or the temperature sensor 280) of the ring electronic device 200 may be disposed on the substrate 295. The components disposed on the substrate 295 may be electrically connected to one another.

According to an embodiment, the ring electronic device 200 may include a camera (or an image sensor). The camera may be disposed in the housing (e.g., the first housing) of the ring electronic device 200. Using the camera, the ring electronic device 200 may detect a motion (or a motion input) of the user associated with the ring electronic device 200. Using data received from the camera, the ring electronic device 200 (e.g., the processor 210) may detect the motion of the user. Using the camera, the ring electronic device 200 may sense a surrounding environment associated with the ring electronic device 200. The motion of the user may include a movement, a gesture, or a pose of the body (e.g., a finger, back of hand, palm, etc.) of the user. The motion of the user may include a motion of a hand on which the ring electronic device 200 is worn or a motion of a hand (or a finger) on which the ring electronic device 200 is not worn. The camera may include at least one of a depth camera (or a depth sensor), an infrared camera (or an infrared sensor), or a general digital camera. For example, the camera may include a stereoscopic or time of flight (ToF) depth camera. Depending on the configuration of the ring electronic device 200, a plurality of cameras may be provided.

According to an embodiment, the ring electronic device 200 may detect the motion of the user using the camera and other sensors (e.g., a distance sensor such as an infrared sensor, an ultrasonic sensor, a laser sensor, and a capacitive sensor, the biometric sensor 250, the touch sensor 260, and the inertial sensor 270). The ring electronic device 200 (e.g., the processor 210) may detect the motion of the user using data received from the camera and other sensors. The sensor used to detect a motion may be included in the camera or disposed separately in the ring electronic device 200.

According to an embodiment, the ring electronic device 200 may include a projection circuitry. The projection circuitry may be a component that projects light outward to represent an image (or a screen) and outputs the image onto a projection surface. The projection circuitry may be implemented as a projection part including at least some components of a projector. The projection circuitry may include at least one light source, a projection lens, a reflector, and the like. The ring electronic device 200 may output a screen through a projection lens disposed in the housing (e.g., the first housing) of the ring electronic device 200 by controlling the projection circuitry. The projection circuitry may include various types of light sources. For example, the projection circuitry may include at least one light source among a lamp, a light-emitting diode (LED), and a laser. The projection circuitry may output an image with various aspect ratios depending on the projected screen, user settings, or the like and may output an image with various resolutions depending on the aspect ratio.

According to an embodiment, the processor 210 of the ring electronic device 200 may generate a screen based on an image signal (e.g., a digital signal) of the screen. The processor 210 may generate the screen by rendering an image signal that forms the basis of the screen. The projection circuitry may output an image to the outside under the control of the processor 210. The projection circuitry may convert the generated screen (or screen data) into an optical signal and output the optical signal to the outside.

According to an embodiment, the projection circuitry may perform various functions to adjust the projection screen that is output under the control of the processor 210. For example, the projection circuitry may perform functions such as zoom, keystone, and lens shift.

For example, the projection circuitry may enlarge or reduce an image depending on the projection distance. For example, a zoom function may be performed depending on the distance from a projection surface. In this case, the zoom function may include a hardware technique that adjusts the size of a screen by moving a lens and a software technique that adjusts the size of the screen by cropping an image or the like. When the zoom function is performed, the focus of the image may need to be adjusted. For example, a focus adjustment technique may include a manual focus technique, a motorized technique, and the like. The manual focus technique may be a technique for adjusting the focus manually, and the motorized technique may be a technique in which the projection circuitry automatically adjusts the focus using a built-in motor when the zoom function is performed. When performing the zoom function, the projection circuitry may provide a digital zoom function through software or an optical zoom function that performs the zoom function by moving a lens.

The projection circuitry may perform a keystone correction function. The keystone correction function may be a function of correcting a distorted projection screen. For example, the projection circuitry may correct distortion in the left-right direction of the projection screen using a horizontal keystone and may correct distortion in the up-down direction using a vertical keystone. A quick corner (4-corner) keystone correction function may be a function of adjusting a screen when the central area of the screen appears normal but the corner areas are misaligned. A lens shift function may be a function of shifting a screen as a whole when an image extends beyond the screen.

The projection circuitry may automatically analyze the surrounding environment without a user input to provide the zoom, keystone, and focus functions. For example, the projection circuitry may automatically provide the zoom, keystone, and focus functions based on information such as the distance between the ring electronic device 200 and the projection screen, the current projection state of the projection screen, the projection screen of a ring electronic device worn on another finger when the user wears a plurality of ring electronic devices on different fingers, and the ambient light level, as detected through components of the ring electronic device 200 such as a camera, a distance sensor, and an illuminance sensor.

According to an embodiment, the projection circuitry may adjust the length of each side (or edge) of the projection screen that is output under the control of the processor 210, the position of the projection screen, the rotation angle of the projection screen, and the like. The processor 210 may detect the motion of the user using data received from the camera and control the projection circuitry to adjust the projection screen based on the detected motion of the user. According to an embodiment, the processor 210 may control the projection circuitry to generate a projection screen with the length of each side of the projection screen, the position of the projection screen, the rotation angle of the projection screen, and the like adjusted, and to output the adjusted projection screen.

The ring electronic device 200 according to an embodiment may further include other components (e.g., a display, an ultrasonic sensor, an audio output device, a light-emitting portion, and a haptic module) in addition to the components explicitly illustrated in FIG. 2.

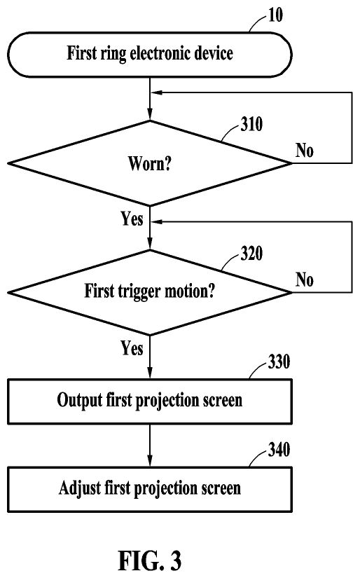

FIG. 3 is a flowchart illustrating an example method of providing a projection screen according to various example embodiments.

According to an embodiment, operations 310 to 350 may be performed by a first ring electronic device 10 (e.g., the electronic device 102 of FIG. 1 or the ring electronic device 200 of FIG. 2). According to an embodiment, the flowchart illustrated in FIG. 3 may include example operations for implementing various embodiments of the present disclosure, and at least some of the operations included in the flowchart may be omitted, changed in order, or replaced with operations of other drawing(s). The first ring electronic device 10 may include at least some of the components of the ring electronic device 200 described with reference to FIG. 2. For example, the first ring electronic device 10 may include at least one processor (e.g., the processor 210 of FIG. 2), memory (e.g., the memory 220 of FIG. 2), a communicator (e.g., the communicator 230 of FIG. 2), a camera, sensor circuitry, and a projection circuitry.

In operation 310, the first ring electronic device 10 may determine (or monitor) the wearing state of the first ring electronic device 10. The first ring electronic device 10 may determine whether the first ring electronic device 10 is worn on the body (e.g., a finger) of a user. As described with reference to FIG. 2, using the sensor circuitry, the first ring electronic device 10 may determine whether the ring electronic device 10 is worn on the finger of the user. Based on data received from the sensor circuitry, the first ring electronic device 10 may determine whether the first ring electronic device 10 is worn on the finger of the user. The first ring electronic device 10 may continue determining the wearing state.

For example, the first ring electronic device 10 may identify that the first ring electronic device 10 is worn on the finger of the user by obtaining biometric information such as HR using the sensor circuitry.

For example, using the sensor circuitry, the first ring electronic device 10 may identify whether the first ring electronic device 10 is worn on the finger of the user based on whether reflected light corresponding to emitted light is received.

According to an embodiment, while any of operations 320 to 340 is performed, when identifying (or detecting) that the first ring electronic device 10 is not worn on the finger of the user, the first ring electronic device 10 may stop the corresponding operation. For example, the first ring electronic device 10 may switch to a locked state or an idle state. For example, the first ring electronic device 10 may control the projection circuitry to stop outputting a screen.

According to an embodiment, using a camera, the first ring electronic device 10 may detect a motion (or a motion input) of the user while the first ring electronic device 10 is worn on the finger of the user. The first ring electronic device 10 (particularly, at least one processor of the first ring electronic device 10) may detect a motion using data received from the camera.

According to an embodiment, using the sensor circuitry, the first ring electronic device 10 may detect that the worn state of the first ring electronic device 10 is maintained. The first ring electronic device 10 may continuously detect a motion while being worn on the finger of the user. That is, the first ring electronic device 10 may detect a motion based on data received from the sensor circuitry until the first ring electronic device 10 identifies that the first ring electronic device 10 is not worn on the finger of the user.

According to an embodiment, the first ring electronic device 10 may detect a motion in a locked state or an idle state. The first ring electronic device 10 may unlock the locked state or idle state based on detecting at least a part of a first trigger motion for the projection screen described below.

According to an embodiment, the first ring electronic device 10 may detect a motion, a gesture, and a pose (hereinafter, a motion) of the body (e.g., fingers, back of hand, palm, etc.) of the user of the first ring electronic device 10. The first ring electronic device 10 may detect a motion of a hand (hereinafter, a first hand) on which the first ring electronic device 10 is worn or a motion of a hand (hereinafter, a second hand) on which the first ring electronic device 10 is not worn.

According to an embodiment, the first ring electronic device 10 may detect a motion directed to at least a part of the user's body. The first ring electronic device 10 may detect a motion of the second hand directed to at least a part of the first hand. The first ring electronic device 10 may detect motions of the palm and back of the first hand or motions of a single finger, multiple fingers, the back or palm, or the like of the second hand directed to the first ring electronic device 10. For example, the first ring electronic device 10 may detect a touch motion such as swipe, pinch, spread, tap, double tap, press-and-hold, and the like when the second hand is directed to at least a part of the first hand. However, the disclosure is not limited thereto.

According to an embodiment, the first ring electronic device 10 may detect a motion of the first hand. For example, the first ring electronic device 10 may detect motions such as a motion of the first hand making a fist, a motion of unfolding fingers of the first hand, and a motion of bending or extending the first finger of the first hand. However, the disclosure is not limited thereto.

As described with reference to FIG. 2, according to an embodiment, the first ring electronic device 10 may detect a motion of the user using data received from the camera. According to an embodiment, the first ring electronic device 10 may detect a motion using the camera and other sensors (a distance sensor, a biometric sensor (e.g., the biometric sensor 250 of FIG. 2), a touch sensor, and the inertial sensor 270).

In operation 320, the first ring electronic device 10 may determine whether at least a part of the first trigger motion for the projection screen is detected. The first trigger motion may be a motion configured to trigger, initiate, or start the output of the first projection screen of the first ring electronic device 10. The first projection screen may be a screen that is output by the first ring electronic device 10. The first trigger motion may be predetermined (e.g., specified) or changed by the user.

According to an embodiment, the first trigger motion may be a motion of swiping (or dragging) directed to at least a part of the first hand on which the first ring electronic device 10 is worn. For example, the first trigger motion may be a motion in which the second hand swipes the back or palm of the first hand. For example, the first trigger motion may be a motion in which any finger of the second hand swipes along the length of a first finger on which the first ring electronic device 10 is worn, on the back or palm of the first hand. The swipe motion may be performed in the direction away from the first ring electronic device 10. The swipe motion may be performed in the direction from the first ring electronic device 10 to the wrist of the first hand.

According to an embodiment, the first trigger motion may be a motion of swiping directed to at least a part of the first hand after a touch (e.g., tap, double tap, swipe, or press-and-hold) input to the first ring electronic device 10. The first ring electronic device 10 may detect the touch input of the user using a touch sensor (e.g., the touch sensor 260). For example, the first trigger motion may be a motion in which the second hand touches the first ring electronic device 10 and swipes the back or palm of the first hand. According to an embodiment, the first ring electronic device 10 may release the locked state or idle state in response to the touch input of the user.

According to an embodiment, the first trigger motion may be a motion of extending a finger of the first hand on which the first ring electronic device 10 is worn. Particularly, the first trigger motion may be a motion of bending and then extending the finger on which the first ring electronic device 10 is worn.

According to an embodiment, the first trigger motion may be a motion of extending fingers of the first hand on which the first ring electronic device 10 is worn. For example, the first trigger motion may be a motion in which the first hand on which the first ring electronic device 10 is worn makes a fist and then extends the fingers.

In operation 330, the first ring electronic device 10 may control the projection circuitry to output the first projection screen on a surface of the user based on detecting at least a part of the first trigger motion for the projection screen.

According to an embodiment, the first ring electronic device 10 may control the projection circuitry to output the first projection screen on the surface of the back or palm of the first hand. For example, the first ring electronic device 10 may control the projection circuitry to output the first projection screen on an area including at least a part of an area placed along the longitudinal direction of the finger on which the first ring electronic device 10 is worn or an area in alignment with the first finger.

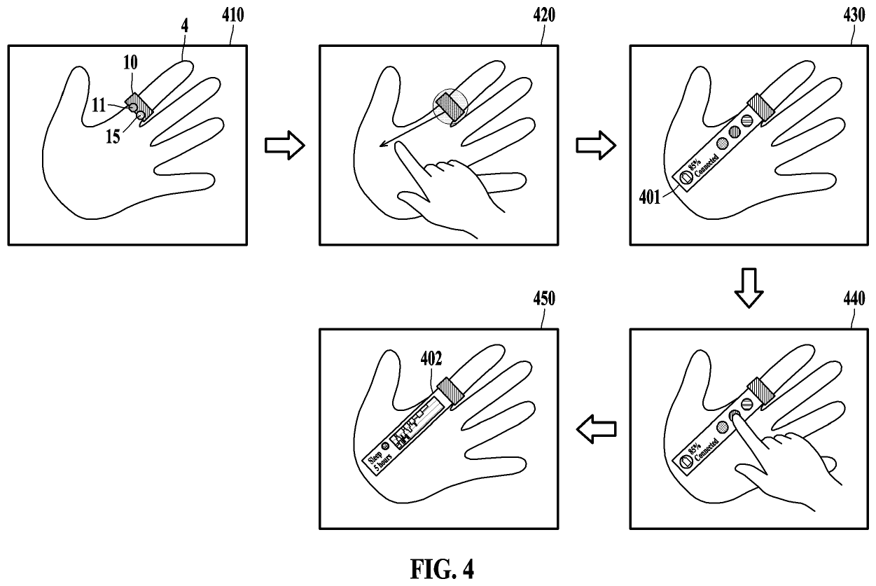

According to an embodiment, the first projection screen is described in greater detail below with reference to FIG. 4.

In operation 340, the first ring electronic device 10 may control the projection circuitry to adjust the first projection screen based on a motion of the user that is detected while the first projection screen is output. As described above, the first ring electronic device 10 may continuously detect the motion (or a motion input) of the user using data received from the camera.

According to an embodiment, the first projection screen may have a left side (or edge), a right side, a near side, and a far side.

According to an embodiment, the first ring electronic device 10 may control the projection circuitry to adjust the length of at least one of the left side, right side, near side, or far side of the first projection screen.

According to an embodiment, the first ring electronic device 10 may control the projection circuitry to adjust the position of the first projection screen.

According to an embodiment, the first ring electronic device 10 may control the projection circuitry to adjust the rotation angle of the first projection screen.

According to an embodiment, the first ring electronic device 10 may control the projection circuitry to adjust at least one of the length of at least one of the left side, right side, near side, or far side of the first projection screen, the position of the first projection screen, or the rotation angle of the first projection screen.

According to an embodiment, the processor of the first ring electronic device 10 may generate a projection screen in which the length of each side, the position, and the rotation angle of the projection screen are adjusted, and may control the projection circuitry to output the adjusted projection screen.

FIG. 4 is a diagram illustrating an example operation of providing a projection screen according to various example embodiments.

FIG. 4 illustrates example states 410 to 450 in which the first ring electronic device 10 (e.g., the electronic device 102 of FIG. 1 or the electronic device 200 of FIG. 2) is worn by a user. The first ring electronic device 10 may include at least some of the components of the ring electronic device 200 described with reference to FIG. 2. For example, the first ring electronic device 10 may include at least one processor (e.g., the processor 210 of FIG. 2), memory (e.g., the memory 220 of FIG. 2), a communicator (e.g., the communicator 230 of FIG. 2), a camera 11, sensor circuitry, and a projection circuitry.

According to an embodiment, the camera 11 and a projection lens 15 of the first ring electronic device 10 described above with reference to FIGS. 2 and 3 are illustrated, but the position, number, and the like of the camera 11 and projection lens 15 are not limited to the illustrated examples. In the present disclosure, any ring electronic device (the first ring electronic device 10, a second ring electronic device 20, or a third ring electronic device 30) may include the camera 11 and the projection lens 15.

In state 410, based on data received from the sensor circuitry, the first ring electronic device 10 may identify that the first ring electronic device 10 is worn on a finger 4 of the user. The first ring electronic device 10 may detect a motion using the camera 11 while being worn on the finger 4 of the user.

In state 420, using data received from the camera 11, the first ring electronic device 10 may detect at least a part of a first trigger motion for a projection screen. Referring to FIG. 4, the user may swipe the palm of a first hand on which the first ring electronic device 10 is worn with a second hand on which the first ring electronic device 10 is not worn.

In state 430, the first ring electronic device 10 may control the projection circuitry to output a first projection screen 401 on the surface of the user based on detecting at least a part of the first trigger motion for the projection screen. Referring to FIG. 4, the first ring electronic device 10 may control the projection circuitry to output the first projection screen 401 on an area (or position) on the palm surface of the first hand in the longitudinal direction of the finger 4.

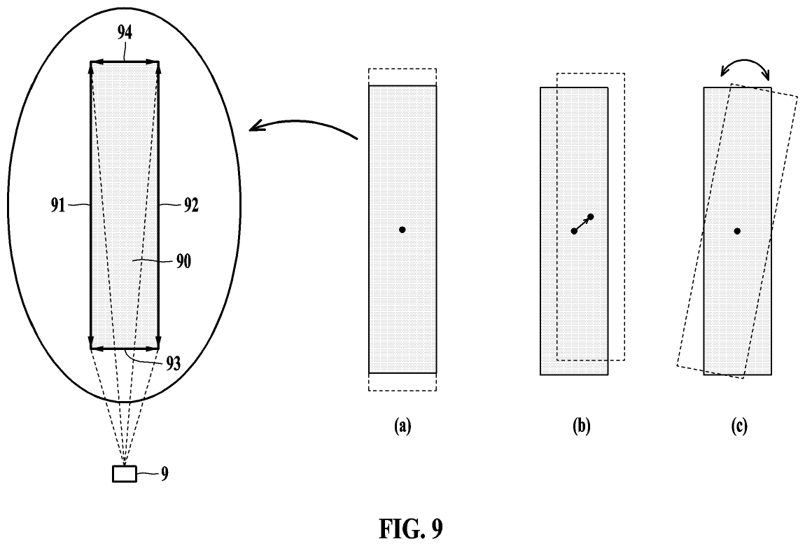

According to an embodiment, the first ring electronic device 10 may control the projection circuitry to output the first projection screen 401 on an area extending from a point that is substantially in contact with the first ring electronic device 10 or from a point that is a predetermined distance away from the first ring electronic device 10 to a point that is a predetermined distance away from the first ring electronic device 10. The position at which the first projection screen 401 is output may vary depending on the size and thickness of the first ring electronic device 10, the position of a lens used for outputting the projection screen, the projection angle and direction according to the control of the projection circuitry, and the like. However, the disclosure is not limited thereto. As described with reference to FIG. 2, the first ring electronic device 10 may adjust the output of the first projected screen 401 using the projection circuitry to perform functions such as zoom, keystone, and lens shift. Referring to FIGS. 9 to 11B, a method of adjusting the output of the first projection screen 401 based on a motion of a user is described in greater detail.

According to an embodiment, the first ring electronic device 10 may generate the first projection screen 401 having a predetermined size (e.g., width and height or width and length, or aspect ratio) and may control a projection circuitry to output the first projection screen 401.

According to an embodiment, the first ring electronic device 10 may generate the first projection screen 401 having a size that is adaptively adjusted in response to content and may control a projection circuitry to output the first projection screen 401.

According to an embodiment, using at least one processor, the first ring electronic device 10 may generate the first projection screen 401 based on an image signal (e.g., a digital signal) that forms the basis of the first projection screen 401. The first ring electronic device 10 may generate the first projection screen 401 by rendering an image signal for a user interface corresponding to the content of the first ring electronic device 10. That is, the first ring electronic device 10 may generate the first projection screen 401 for a user interface corresponding to the content of the first ring electronic device 10. For example, the content of the first ring electronic device 10 may include an application executed by the first ring electronic device 10, a screen (e.g., a home screen) displayed on the first ring electronic device 10, or information received or detected by the first ring electronic device 10.

According to an embodiment, the first ring electronic device 10 may generate the first projection screen 401 for a user interface corresponding to an application executed by the first ring electronic device 10.

According to an embodiment, the first ring electronic device 10 may generate the first projection screen 401 for a user interface corresponding to a screen (e.g., a home screen) displayed on the first ring electronic device 10.

According to an embodiment, the first ring electronic device 10 may generate the first projection screen 401 for a user interface corresponding to information received or detected by the first ring electronic device 10. For example, the first ring electronic device 10 may receive a task (or information regarding a task) associated with the first ring electronic device 10 from an external electronic device (e.g., the electronic device 101 of FIG. 1) connected to the first ring electronic device 10. For example, the first ring electronic device 10 may detect a task associated with an application included in the first ring electronic device 10.

According to an embodiment, the first ring electronic device 10 may generate and output the first projection screen 401 based on a first trigger motion. For example, the first ring electronic device 10 may detect an end point of a swipe motion (e.g., the point where a finger of a second hand swipes across and touches off on the back or palm of the first hand) and determine the size of the first projection screen 401 based on that point (or the distance to that point). The first ring electronic device 10 may generate the first projection screen 401 sized such that the first projection screen 401 is output up to the end point of the swipe motion and may control the projection circuitry to output the first projection screen 401.

According to an embodiment, the first projection screen 401 may be a user interface for interaction between the first ring electronic device 10 and the user. The first ring electronic device 10 may execute various functions and commands or perform operations based on a user input (e.g., a motion) for the first projection screen 401 and may output, as the first projection screen 401, a changed screen accordingly.

According to an embodiment, the first projection screen 401 may include a user interface corresponding to a home screen (or a default screen). The home screen may be a screen for executing various functions of the first ring electronic device 10, rather than the execution screen of a predetermined application. The home screen may include, but is not limited to, the battery state of the first ring electronic device 10, a communication state, a connection state with another electronic device, an application icon, a widget, and a folder. For example, components of the home screen may be added or removed, or the arrangement of the components may be changed, based on user settings. For example, the first projection screen 401 may always include some states (e.g., battery state, communication state, or connection state with another electronic device).

According to an embodiment, the first projection screen 401 may include a user interface corresponding to the execution screen of an application executed by the first ring electronic device 10.

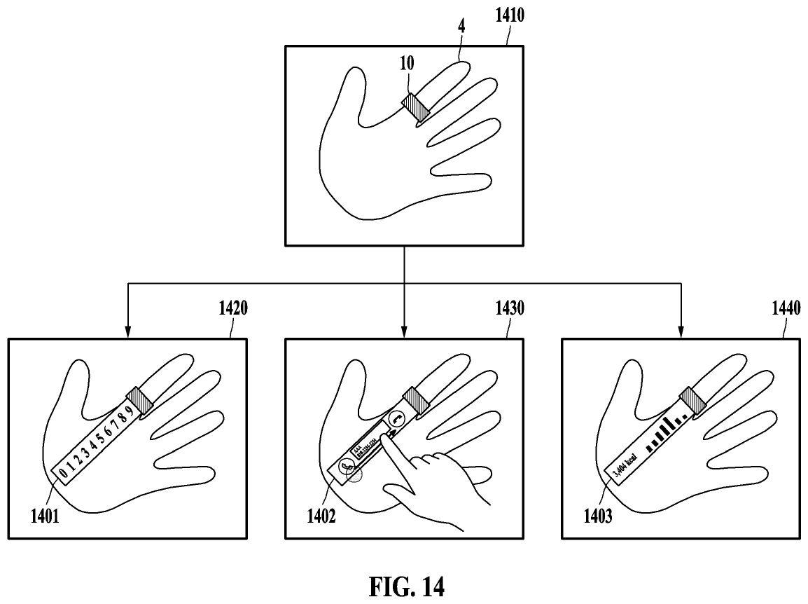

According to an embodiment, the first projection screen 401 may be determined based on a task associated with the first ring electronic device 10. A user interface corresponding to a task associated with the first ring electronic device 10 is described in greater detail below with reference to FIG. 14.

According to an embodiment, the first ring electronic device 10 may receive, from an external electronic device (e.g., the electronic device 101 of FIG. 1) connected to the first ring electronic device 10, information regarding the first projection screen 401 corresponding to the content of the external electronic device. The first ring electronic device 10 may control the projection circuitry to output the first projection screen 401 based on the information regarding the first projection screen 401.

In state 440, the first ring electronic device 10 may detect at least a part of a tap motion on the first projection screen 401 using data received from the camera 11 while the first projection screen 401 is output. Referring to FIG. 4, the user may tap an application included in the first projection screen 401.

In state 450, the first ring electronic device 10 may generate a first changed projection screen 402 for a user interface changed in response to the tap motion of the user and may control the projection circuitry to output the first changed projection screen 402 as the first projection screen 401. For example, the first ring electronic device 10 may output the first changed projection screen 402 in place of the first projection screen 401. Referring to FIG. 4, the first ring electronic device 10 may execute an application included in the first projection screen 401 in response to a tap motion that taps the application. The first ring electronic device 10 may generate the first changed projection screen 402 for a changed user interface corresponding to the execution screen of an application. The first ring electronic device 10 may output the first changed projection screen 402.

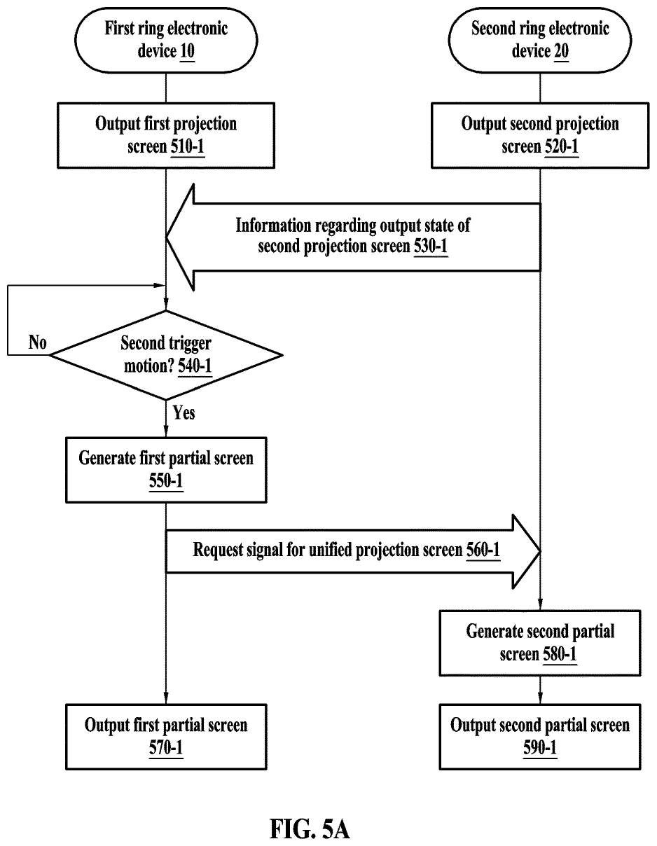

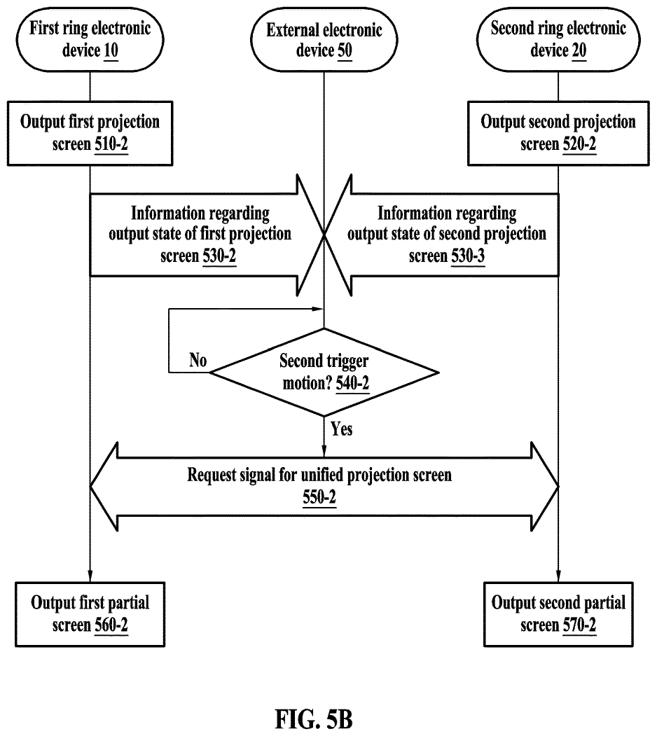

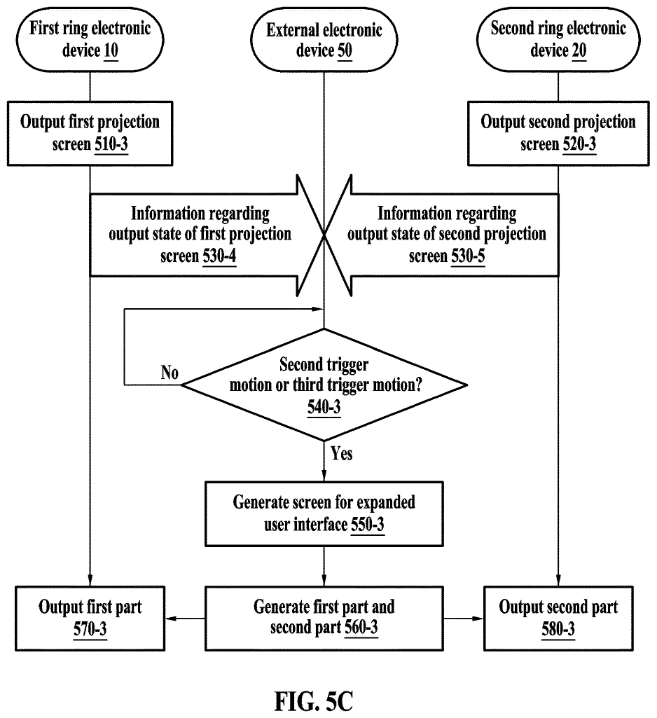

FIGS. 5A, 5B, and 5C are signal flow diagrams illustrating an example method of providing a unified projection screen according to various example embodiments.

According to an embodiment, the following operations may be performed by the first ring electronic device 10 (e.g., the electronic device 102 of FIG. 1 or the ring electronic device 200 of FIG. 2), the second ring electronic device 20 (e.g., the electronic device 102 of FIG. 1 or the ring electronic device 200 of FIG. 2), and an external electronic device 50 (e.g., the electronic device 101 of FIG. 1). According to an embodiment, the flowchart illustrated in FIGS. 5A, 5B, and 5C may include example operations for implementing various embodiments of the present disclosure, and at least some of the operations included in the flowchart may be omitted, changed in order, or replaced with operations of other drawing(s). The first ring electronic device 10 and the second ring electronic device 20 may each include at least some of the components of the ring electronic device 200 described with reference to FIG. 2. For example, the first ring electronic device 10 and the second ring electronic device 20 may include at least one processor (e.g., the processor 210 of FIG. 2), memory (e.g., the memory 220 of FIG. 2), a communicator (e.g., the communicator 230 of FIG. 2), a camera (e.g., the camera 11 of FIG. 4), sensor circuitry, and a projection circuitry. The external electronic device 50 may be a user terminal (e.g., a wearable device such as a smartphone and smartwatch) connected to the first ring electronic device 10 and the second ring electronic device 20 via wireless communication. FIGS. 5A, 5B, and 5C illustrate an embodiment in which a unified projection screen is provided when a user wears the first ring electronic device 10 and the second ring electronic device 20.

According to an embodiment, the description of the first ring electronic device 10 may also apply to the second ring electronic device 20. In the present disclosure, for ease of description, elements (e.g., a projection screen, a partial screen, etc.) associated with the first ring electronic device 10 are referred to as “first-,” and elements associated with the second ring electronic device 20 are referred to as “second-.”

As described with reference to FIGS. 3 and 4, the second ring electronic device 20 may determine the wearing state of the second ring electronic device 20. The second ring electronic device 20 may identify that the second ring electronic device is worn on a finger of a user based on data received from the sensor circuitry. The second ring electronic device 20 may detect a motion using the camera while being worn on the finger of the user. The first ring electronic device 20 may determine whether at least a portion of a first trigger motion for a projection screen is detected. The second ring electronic device 20 may control the projection circuitry to output a second projection screen, based on detecting at least a part of the first trigger motion for the projection screen. A second projection screen may be a screen that is output by the second ring electronic device 20. For the second ring electronic device 20, any redundant descriptions already provided for the first ring electronic device 10 may not be repeated here.

An embodiment is described with reference to FIG. 5A.

In operation 510-1, the first ring electronic device 10 may control the projection circuitry to output the first projection screen. For example, operation 510-1 may be operation 330 of outputting the first projection screen of FIG. 3.

In operation 520-1, the second ring electronic device 20 may control the projection circuitry to output the second projection screen.

In operation 530-1, the second ring electronic device 20 may transmit, to the first ring electronic device 10, information regarding the output state of the second projection screen. The first ring electronic device 10 may receive, from the second ring electronic device 20, the information regarding the output state of the second projection screen.

According to an embodiment, the information regarding the output state of the second projection screen may include information regarding whether the second ring electronic device 20 outputs the second projection screen. For example, when outputting the second projection screen based on detecting at least a part of the first trigger motion, the second ring electronic device 20 may transmit, to the first ring electronic device 10, information indicating that the second projection screen is output.

According to an embodiment, the information regarding the output state of the second projection screen may further include information regarding a user interface corresponding to the second projection screen. For example, the information regarding the output state of the second projection screen may include information regarding whether the second projection screen is a home screen or information regarding an application (e.g., an application being executed by the second ring electronic device 20) corresponding to an execution screen displayed on the second projection screen.

According to an embodiment, the first projection screen and the second projection screen may be output in any order. For example, operations 510-1 and 520-1 may be performed in any order. For example, operation 520-1 may be performed after operation 510-1 is performed. For example, operation 510-1 may be performed after operation 520-1 is performed. Therefore, although operation 530-1 is illustrated as being performed after operation 510-1, when the second projection screen is output before the first projection screen, operation 530-1 may be performed before operation 510-1.

According to an embodiment, the second ring electronic device 20 may perform operation 530-1 at predetermined time intervals. For example, the second ring electronic device 20 may transmit, to the first ring electronic device 10, the information regarding the output state of the second projection screen at predetermined time intervals. According to an embodiment, the second ring electronic device 20 may transmit, to the first ring electronic device 10, the information regarding the output state of the second projection screen when the output state of the second projection screen is changed. For example, the second ring electronic device 20 may transmit, to the first ring electronic device 10, the information regarding the output state of the second projection screen when the output of the second projection screen starts, the output of the second projection screen stops, or the execution screen displayed on the second projection screen is changed (e.g., the execution state of the application is changed).

In operation 540-1, while the first projection screen and the second projection screen are output, using data received from the camera, the first ring electronic device 10 may determine whether at least a part of a second trigger motion for a unified projection screen of the first ring electronic device 10 and the second ring electronic device 20 is detected. The second trigger motion may be a motion configured to trigger, initiate, or start the output of a unified projection screen of a plurality of ring electronic devices (e.g., the first ring electronic device 10 and the second ring electronic device 20). The second trigger motion may be preset (e.g., specified) or changed by a user.

According to an embodiment, the unified projection screen may be a large screen including projection screens of a plurality of ring electronic devices (e.g., the first ring electronic device 10 and the second ring electronic device 20). The unified projection screen may be an integrated (or unified) projection screen across the plurality of ring electronic devices. The unified projection screen may include a plurality of partial screens.

According to an embodiment, when the user wears a plurality of ring electronic devices, generally each of the plurality of ring electronic devices may independently output a projection screen. The projection angle, direction, or size of each projection screen may be determined according to the settings of each ring electronic device. In contrast, a unified projection screen may include a plurality of partial screens arranged in succession. The plurality of partial screens may be arranged without gaps.

According to an embodiment, partial screens of a unified projection screen may each display individual content of a ring electronic device that outputs a corresponding partial screen. For example, each partial screen may be an independent user interface.

According to an embodiment, the partial screens of the unified projection screen may display the same content. For example, each partial screen may be a different part of an expanded user interface corresponding to the same content. For example, the partial screens of the unified projection screen may display the content of a predetermined ring electronic device or the content of an external electronic device (e.g., the external electronic device 50) connected to the plurality of ring electronic devices. Hereinafter, a first partial screen of the first ring electronic device 10 and a second partial screen of the second ring electronic device 20 are described.

According to an embodiment, the second trigger motion may be a motion of pinching (or gathering) directed toward at least a part of a first hand on which the first ring electronic device 10 is worn. The second trigger motion may be a motion in which a second hand pinches the first projection screen and the second projection screen displayed on the back or palm of the first hand. Particularly, the second trigger motion may be a pinch motion in which any fingers of the second hand move toward each other at arbitrary points on the first projection screen and arbitrary points on the second projection screen, respectively.

According to an embodiment, the first ring electronic device 10 may receive, from the second ring electronic device 20, information regarding a motion detected using the camera of the second ring electronic device 20.

According to an embodiment, the second ring electronic device 20 may continuously transmit the information regarding the motion to the first ring electronic device 10. For example, the second ring electronic device 20 may transmit, to the first ring electronic device 10, data about a motion detected in real time. Based on the received data about a motion, the first ring electronic device 10 may determine whether at least a part of the second trigger motion is detected. For example, the first ring electronic device 10 may determine whether the motion detected by the first ring electronic device 10 and/or the motion detected by the second ring electronic device 20 includes at least a part of the second trigger motion.

According to an embodiment, the second ring electronic device 20 may transmit, to the first ring electronic device 10, information regarding a predetermined type of motion (or information regarding whether a predetermined type of motion is detected). For example, a predetermined type of motion may include at least one of the motions described in the present disclosure, such as a first trigger motion, a second trigger motion, a third trigger motion, for example a swipe motion, a tap motion, a double tap motion, a press-and-hold motion, or a pinch motion. Based on detecting at least a part of the second trigger motion, the second ring electronic device 20 may transmit, to the first ring electronic device 10, information regarding whether the second trigger motion is detected.

In operation 550-1, the first ring electronic device 10 may generate the first partial screen for the unified projection screen, based on detecting at least a part of the second trigger motion.

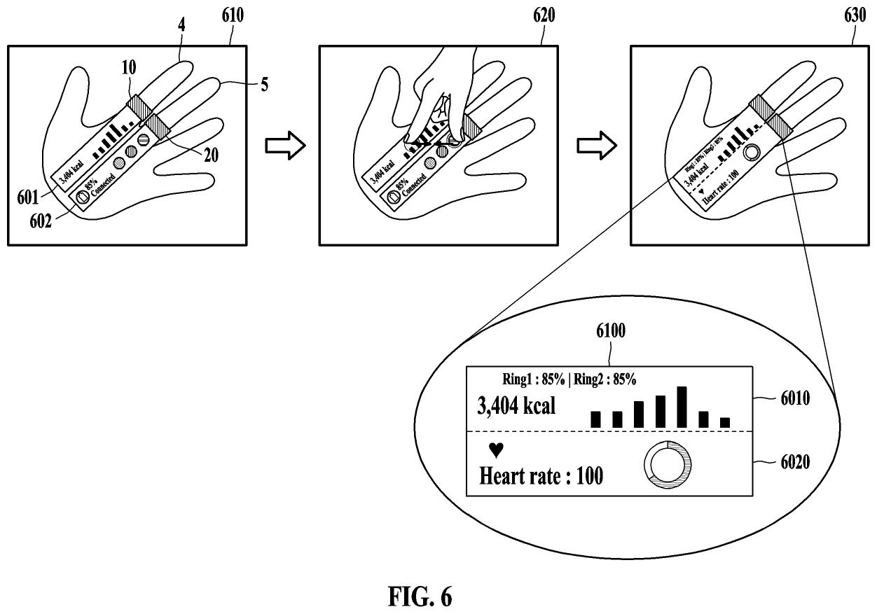

According to an embodiment, the first ring electronic device 10 may generate the first partial screen having a size that is different from the size of the first projection screen. For example, the first ring electronic device 10 may generate the first partial screen that is an enlarged version of the first projection screen. For example, the first ring electronic device 10 may generate the first partial screen of a size in which the width and/or length of the first projection screen is expanded or reduced. The first partial screen is described in greater detail below with reference to FIG. 6.

In operation 560-1, the first ring electronic device 10 may transmit a request signal for the unified projection screen to the second ring electronic device 20.

Referring to FIG. 5A, it is illustrated that after operation 550-1 of generating the first partial screen for the unified projection screen, operation 560-1 of transmitting the request signal for the unified projection screen may be performed. However, the disclosure is not limited thereto. Operation 550-1 and operation 560-1 may be performed in parallel, or operation 550-1 may be performed after operation 560-1.

According to an embodiment, the request signal for the unified projection screen may include a request, command, or control signal for starting the unified projection screen. However, the disclosure is not limited thereto.

In operation 570-1, using the projection circuitry, the first ring electronic device 10 may control the projection circuitry to output, as the first projection screen, the first partial screen for the unified projection screen. For example, the first ring electronic device 10 may output the first partial screen in place of the first projection screen.

In operation 580-1, the second ring electronic device 20 may generate the second partial screen for the unified projection screen based on the request signal for the unified projection screen.

According to an embodiment, the second ring electronic device 20 may generate the second partial screen having a size that is different from the size of the second projection screen. For example, the second ring electronic device 20 may generate the second partial screen that is an enlarged version of the second projection screen. For example, the second ring electronic device 20 may generate the second partial screen of a size in which the width and/or length of the second projection screen is expanded or reduced. The second partial screen is described in detail with reference to FIG. 6.

In operation 590-1, using the projection circuitry, the second ring electronic device 20 may control the projection circuitry to output, as the second projection screen, the second partial screen for the unified projection screen. In other words, the second ring electronic device 20 may output the second partial screen in place of the second projection screen.

An embodiment is described with reference to FIG. 5B.

In operation 510-2, the first ring electronic device 10 may control the projection circuitry to output the first projection screen.

In operation 520-2, the second ring electronic device 20 may control the projection circuitry to output the second projection screen.

According to an embodiment, the first projection screen and the second projection screen may be output in any order. That is, operations 510-2 and 520-2 may be performed in any order.

In operation 530-2, the first ring electronic device 10 may transmit, to the external electronic device 50, information regarding the output state of the first projection screen. In operation 530-3, the second ring electronic device 20 may transmit, to the external electronic device 50, information regarding the output state of the second projection screen. The external electronic device 50 may receive information regarding the output state of the first projection screen from the first ring electronic device 10 and the output state of the second projection screen from the second ring electronic device 20. The description of the information regarding the output state of the second projection screen of the second ring electronic device 20 provided with reference to FIG. 5A may also apply to the information regarding the output state of the first projection screen of the first ring electronic device 10, so any redundant descriptions may not be repeated here.

According to an embodiment, the first ring electronic device 10 and the second ring electronic device 20 may perform operation 530-2 and operation 530-3, respectively, at predetermined time intervals.

According to an embodiment, when the output state of the first projection screen or the output state of the second projection screen is changed, the first ring electronic device 10 and the second ring electronic device 20 may respectively transmit, to the external electronic device 50, the information regarding the output state of the first projection screen or the second projection screen.

According to an embodiment, the screen projection of the first ring electronic device 10 and the second ring electronic device 20 may be controlled by the external electronic device 50. In various implementations, some operations may be omitted for simplicity and efficiency. For example, operation 530-4 of transmitting the information regarding the output state of the first projection screen and operation 530-5 of transmitting the information regarding the output state of the second projection screen may be omitted.

In operation 540-2, the external electronic device 50 may determine whether at least a part of the second trigger motion for the unified projection screen of the first ring electronic device 10 and the second ring electronic device 20 is detected.

According to an embodiment, the external electronic device 50 may receive information regarding a motion detected using a camera from the first ring electronic device 10 and/or the second ring electronic device 20.

According to an embodiment, the first ring electronic device 10 and/or the second ring electronic device 20 may continuously transmit the information regarding a motion to the external electronic device 50. For example, the first ring electronic device 10 and/or the second ring electronic device 20 may transmit, to the external electronic device 50, data about a motion detected in real time. Based on the received data about a motion, the external electronic device 50 may determine whether at least a part of the second trigger motion is detected. For example, the external electronic device 50 may determine whether the motion detected by the first ring electronic device 10 and/or the motion detected by the second ring electronic device 20 includes at least a part of the second trigger motion.

According to an embodiment, the first ring electronic device 10 and/or the second ring electronic device 20 may transmit, to the external electronic device 50, information regarding a predetermined type of motion (or information regarding whether a predetermined type of motion is detected). The external electronic device 50 may receive information regarding whether the second trigger motion is detected from the first ring electronic device 10 and/or the second ring electronic device 20.

In operation 550-2, the external electronic device 50 may transmit a request signal for the unified projection screen to the first ring electronic device 10 and the second ring electronic device 20. Based on the request signal for the unified projection screen, the first ring electronic device 10 and the second ring electronic device 20 may generate the first partial screen for the unified projection screen and the second partial screen, respectively.

In operation 560-2, the first ring electronic device 10 may control the projection circuitry to output the first partial screen.

In operation 570-2, the second ring electronic device 20 may control the projection circuitry to output the second partial screen.

An embodiment is described with reference to FIG. 5C.

In operation 510-3, the first ring electronic device 10 may control the projection circuitry to output the first projection screen.

In operation 520-3, the second ring electronic device 20 may control the projection circuitry to output the second projection screen.

According to an embodiment, the first projection screen and the second projection screen may be output in any order. For example, operations 510-3 and 520-3 may be performed in any order.

In operation 530-4, the first ring electronic device 10 may transmit, to the external electronic device 50, information regarding the output state of the first projection screen. In operation 530-5, the second ring electronic device 20 may transmit, to the external electronic device 50, information regarding the output state of the second projection screen. Any repeated description related to the description provided above may not be provided here.

According to an embodiment, the screen projection of the first ring electronic device 10 and the second ring electronic device 20 may be controlled by the external electronic device 50. In various implementations, some operations may be omitted for simplicity and efficiency. For example, operation 530-4 of transmitting the information regarding the output state of the first projection screen and operation 530-5 of transmitting the information regarding the output state of the second projection screen may be omitted.

In operation 540-3, the external electronic device 50 may determine whether at least a part of the second trigger motion for the unified projection screen of the first ring electronic device 10 and the second ring electronic device 20 or at least a part of a third trigger motion for expanding a user interface is detected.

According to an embodiment, the third trigger motion may be a motion configured to trigger, initiate, or start the output of an expanded user interface corresponding to the same content across a plurality of ring electronic devices (e.g., the first ring electronic device 10 and the second ring electronic device 20). The third trigger motion may be preset or changed by the user.

According to an embodiment, the external electronic device 50 may receive information regarding a motion detected using the camera from the first ring electronic device 10 and/or the second ring electronic device 20.

According to an embodiment, the first ring electronic device 10 and/or the second ring electronic device 20 may continuously transmit the information regarding a motion to the external electronic device 50. For example, the first ring electronic device 10 and/or the second ring electronic device 20 may transmit, to the external electronic device 50, data about a motion detected in real time. Based on the received data about a motion, the external electronic device 50 may determine whether at least a part of the second trigger motion or at least a part of the third trigger motion is detected. For example, the external electronic device 50 may determine whether the motion detected by the first ring electronic device 10 and/or the motion detected by the second ring electronic device 20 includes at least a part of the second trigger motion or at least a part of the third trigger motion.

According to an embodiment, the first ring electronic device 10 and/or the second ring electronic device 20 may transmit information regarding a predetermined type of motion to the external electronic device 50. The external electronic device 50 may receive information regarding whether the second trigger motion or the third trigger motion is detected from the first ring electronic device 10 and/or the second ring electronic device 20.

According to an embodiment, based on detecting at least a part of the second trigger motion or at least a part of the third trigger motion, the first ring electronic device 10 and/or the second ring electronic device 20 may transmit, to the external electronic device 50, a request signal for expanding a user interface.

In operation 550-3, based on detecting at least a part of the second trigger motion or at least part of the third trigger motion, the external electronic device 50 may generate a screen for an expanded interface corresponding to the content of the external electronic device 50. For example, the external electronic device 50 may generate a screen by rendering an image signal for the expanded user interface.

According to an embodiment, when the external electronic device 50 is in use at the point in time at which the second trigger motion or the third trigger motion is detected, the external electronic device 50 may generate a screen based on the state of the external electronic device 50 at that point in time. For example, when the external electronic device 50 is unlocked and the home screen is displayed, or the execution screen of an application is displayed, a screen for an expanded user interface corresponding to that content may be generated. For example, when the home screen of the external electronic device 50 is displayed but an application is running in the background or the application is running in a locked state, a screen for an expanded user interface corresponding to the execution screen of the application may be generated.

According to an embodiment, when the external electronic device 50 is not in use (e.g., locked state or idle state) at the point in time at which the second trigger motion or the third trigger motion is detected, the external electronic device 50 may output feedback (e.g., haptic feedback or notification push). When the user operates the external electronic device 50 or executes a predetermined function, a screen for an expanded interface corresponding to that content may be generated.

According to an embodiment, when the external electronic device 50 is not in use at the point in time at which the second trigger motion or the third trigger motion is detected, the external electronic device 50 may generate a screen for an expanded user interface corresponding to a home screen.

In operation 560-3, the external electronic device 50 may generate a first part and a second part, which are different portions of a screen for an expanded user interface corresponding to the content of the external electronic device 50. The external electronic device 50 may divide, into a first part and a second part, the screen that is generated by rendering an image signal for an expanded interface. The external electronic device 50 may transmit the first part and the second part to the first ring electronic device 10 and the second ring electronic device 20, respectively.

According to an embodiment, operation 550-3 of generating a screen for an expanded user interface may be omitted. Based on detecting at least a part of the second trigger motion or the third trigger motion, the external electronic device 50 may generate an image signal of the first part and an image signal of the second part of the screen for the expanded interface corresponding to the content of the external electronic device 50. The external electronic device 50 may generate the first part by rendering the image signal of the first part and generate the second part by rendering the image signal of the second part. The external electronic device 50 may transmit the first part and the second part to the first ring electronic device 10 and the second ring electronic device 20, respectively.

According to an embodiment, the external electronic device 50 may transmit the image signal of the first part and the image signal of the second part to the first ring electronic device 10 and the second ring electronic device 20, respectively. The first ring electronic device 10 may generate the first part by rendering the image signal of the first part, and the second ring electronic device 20 may generate the second part by rendering the image signal of the second part.

In operation 570-3, the first ring electronic device 10 may control the projection circuitry to output the first part as the first projection screen.

In operation 580-3, the second ring electronic device 20 may control the projection circuitry to output the second part as the second projection screen.

FIG. 6 is a diagram illustrating an example operation of providing a unified projection screen, according to various example embodiments.

FIG. 6 illustrates states 610, 620 and 630 in which the first ring electronic device 10 (e.g., the electronic device 102 of FIG. 1 or the electronic device 200 of FIG. 2) and the second ring electronic device 20 (e.g., the electronic device 102 of FIG. 1 or the electronic device 200 of FIG. 2) are worn by a user. The first ring electronic device 10 and the second ring electronic device 20 may each include at least some of the components of the ring electronic device 200 described with reference to FIG. 2. For example, the first ring electronic device 10 and the second ring electronic device 20 may include at least one processor (e.g., the processor 210 of FIG. 2), memory (e.g., the memory 220 of FIG. 2), a communicator (e.g., the communicator 230 of FIG. 2), a camera (e.g., the camera 11 of FIG. 4), sensor circuitry, and a projection circuitry.

According to an embodiment, while being worn on the finger 4 of a user, using the camera, the first ring electronic device 10 may continuously detect a motion of the user. While being worn on a finger 5 of the user, using the camera, the second ring electronic device 20 may continuously detect a motion of the user.

In state 610, the first ring electronic device 10 may control the projection circuitry to output a first projection screen 601 on the surface of the user associated with the finger 4. The second ring electronic device 20 may control the projection circuitry to output a second projection screen 602 on the surface of the user associated with the finger 5. The first ring electronic device 10 and the second ring electronic device 20 may independently output the first projection screen 601 and the second projection screen 602, respectively, and the projection angle, direction, or size of each of the first projection screen 601 and the second projection screen 602 may be determined according to the settings of the first ring electronic device 10 and the second ring electronic device 20.

According to an embodiment, the first ring electronic device 10 may receive, from the second ring electronic device 20, information regarding the output state of the second projection screen 602.

According to an embodiment, while the first projection screen 601 and the second projection screen 602 are output, the first ring electronic device 10 may determine whether at least a part of a second trigger motion for a unified projection screen is detected.

According to an embodiment, the first ring electronic device 10 may further receive, from the second ring electronic device 20, information regarding a motion detected by the second ring electronic device 20. While the first projection screen 601 and the second projection screen 602 are output, the first ring electronic device 10 may determine whether the motion detected by the first ring electronic device 10 and/or the motion detected by the second ring electronic device 20 includes at least a part of the second trigger motion.

In state 620, according to an embodiment, the first ring electronic device 10 may detect at least a pa rt of the second trigger motion based on data received from the camera. According to an embodiment, the first ring electronic device 10 may determine that the motion detected by the first ring electronic device 10 and/or the motion detected by the second ring electronic device 20 includes at least a part of the second trigger motion. Referring to FIG. 6, the user may perform a pinch gesture using fingers of a second hand on which the first ring electronic device 10 and the second ring electronic device 20 are not worn, by touching arbitrary points on the first projection screen 601 and the second projection screen 602 displayed on the first hand on which the first ring electronic device 10 and the second ring electronic device 20 are worn, and by bringing the fingers closer together.

According to an embodiment, based on detecting at least a part of the second trigger motion, the first ring electronic device 10 may generate a first partial screen 6010 for a unified projection screen 6100 and transmit a request signal for the unified projection screen to the second ring electronic device 20. Based on the request signal for the unified projection screen, the second ring electronic device 20 may generate a second partial screen 6020 for the unified projection screen 6100.

In state 630, the first ring electronic device 10 may control the projection circuitry to output, as the first projection screen 610, the first partial screen 6010 for the unified projection screen 6100. In other words, the first ring electronic device 10 may output the first partial screen 6010 in place of the first projection screen 601. The second ring electronic device 20 may control the projection circuitry to output, as the second projection screen 602, the second partial screen 6020 for the unified projection screen 6100. For example, the second ring electronic device 20 may output the second partial screen 6020 in place of the second projection screen 602.

According to an embodiment, referring to FIG. 6, the unified projection screen 6100 may include the first partial screen 6010 and the second partial screen 6020. The unified projection screen 6100 may include the first partial screen 6010 and the second partial screen 6020 arranged consecutively. The first partial screen 6010 and the second partial screen 6020 may be arranged without gaps.

Hereinafter, the unified projection screen 6100 and various methods of configuring the same are described in greater detail.

According to an embodiment, the first partial screen 6010 and the second partial screen 6020 of the unified projection screen 6100 may respectively display individual content of the first ring electronic device 10 and the second ring electronic device 20. For example, the first partial screen 6010 and the second partial screen 6020 may be independent user interfaces. The unified projection screen 6100 may include the first partial screen 6010 that includes the content displayed by the first projection screen 601 as is and the second partial screen 6020 that includes the content displayed by the second projection screen 602 as is.

For example, when a second trigger motion for the unified projection screen is detected while the first projection screen 601 and the second projection screen 602 are output as independent user interfaces, the first partial screen 6010 for a user interface corresponding to the content of the first ring electronic device 10 and the second partial screen 6020 for a user interface corresponding to the content of the second ring electronic device 20 may be output as the first projection screen 601 and the second projection screen 602, respectively. Based on detecting at least a part of the second trigger motion, the first ring electronic device 10 may generate and output the first partial screen 6010 for a user interface corresponding to the content of the first ring electronic device 10 and transmit a request signal for the unified projection screen to the second ring electronic device 20. Based on the request signal for the unified projection screen, the second ring electronic device 20 may generate and output the second partial screen 6020 for the user interface corresponding to the content of the second ring electronic device 20.

According to an embodiment, different parts of the unified projection screen 6100 for an expanded user interface corresponding to the same content may be output as the first partial screen 6010 and the second partial screen 6020. That is, the first partial screen 6010 and the second partial screen 6020 may form a unified interface.

For example, when a third trigger motion for expanding a user interface is detected for the first partial screen 6010 while the first partial screen 6010 and the second partial screen 6020 are output as independent user interfaces, a screen for an expanded user interface corresponding to the content of the first ring electronic device 10 may be generated. A first part and a second part of the screen for the expanded user interface may be output as the first partial screen 6010 and the second partial screen 6020, respectively.

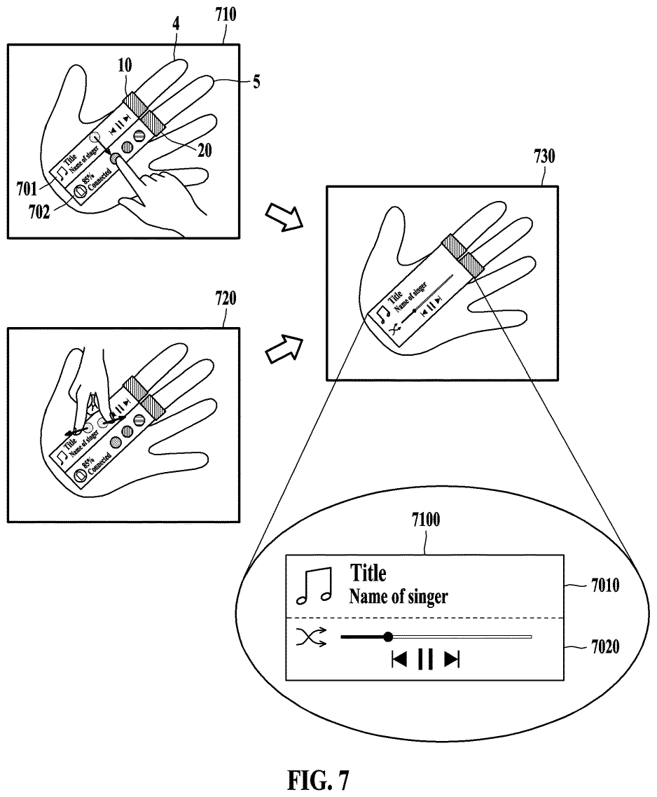

For example, when the third trigger motion for expanding a user interface is detected for the second partial screen 6020 while the first partial screen 6010 and the second partial screen 6020 are output as independent user interfaces, a screen for the expanded user interface corresponding to the content of the second ring electronic device 20 may be generated. The first part and the second part of the screen for the expanded user interface may be output as the first partial screen 6010 and the second partial screen 6020, respectively. An operation of providing partial screens in response to a third trigger motion is described in greater detail below with reference to FIG. 7.

For example, when the second trigger motion for the unified projection screen is detected while any ring electronic device outputs a projection screen for a user interface corresponding to a home screen (simply put, a projection screen displaying the home screen), a first part and a second part of a screen for an expanded user interface corresponding to the content of another ring electronic device that executes any application may be output as the first partial screen 6010 and the second partial screen 6020, respectively. For example, a ring electronic device that does not execute any applications may be excluded when configuring the unified projection screen 6100.

Hereinafter, a case in which the second ring electronic device 20 outputs the second projection screen 602 that displays a home screen is described in greater detail.

The first ring electronic device 10 may output the first projection screen 601 showing the execution screen of a first application. The second ring electronic device 20 may output the second projection screen 602 showing a home screen. As described above with reference to FIG. 5A, the first ring electronic device 10 may receive information regarding the output state of the second projection screen from the second ring electronic device 20. The information regarding the output state of the second projection screen may include whether the second projection screen is a home screen. The first ring electronic device 10 may transmit a request signal for the unified projection screen to the second ring electronic device 20, based on detecting the second trigger motion. The request signal for the unified projection screen may include a request, command, or control signal to start the unified projection screen.

According to an embodiment, the request signal for the unified projection screen may further include any part of the screen for an expanded user interface. The first ring electronic device 10 may generate a screen by rendering an image signal for an expanded user interface corresponding to the content of the first ring electronic device 10, for example, the execution screen of the first application. The first ring electronic device 10 may split the screen for the expanded user interface into a part and another part to generate a first part and a second part. The first ring electronic device 10 may consider the number of other ring electronic devices connected when splitting the screen for the expanded user interface. The first ring electronic device 10 may transmit, to the second ring electronic device 20, the request signal for the unified projection screen including the second part. The first ring electronic device 10 may control the projection circuitry to output the first part as the first partial screen 6010. The second ring electronic device 20 may control the projection circuitry to output the second part as the second partial screen 6020.

According to an embodiment, the request signal for the unified projection screen may further include an image signal (e.g., a digital signal) of any part of the screen for the expanded user interface. The first ring electronic device 10 may generate an image signal of the first part and an image signal of the second part of the screen for the expanded user interface corresponding to the content of the first ring electronic device 10. Using the projection circuitry, the first ring electronic device 10 may generate the first part by rendering the image signal of the first part. The first ring electronic device 10 may transmit, to the second ring electronic device 20, the request signal for the unified projection screen including the image signal of the second part. The second ring electronic device 20 may generate the second part by rendering the image signal of the second part based on the request signal for the unified projection screen. The first ring electronic device 10 may control the projection circuitry to output the first part as the first partial screen 6010. The second ring electronic device 20 may control the projection circuitry to output the second part as the second partial screen 6020.

Hereinafter, a case in which the first ring electronic device 10 outputs the first projection screen 601 that displays a home screen is described in greater detail.

The first ring electronic device 10 may output the first projection screen 601 showing a home screen, and the second ring electronic device 20 may output the second projection screen 602 showing the execution screen of a second application. The first ring electronic device 10 may transmit a request signal for the unified projection screen to the second ring electronic device 20, based on detecting the second trigger motion.

The first ring electronic device 10 may transmit, to the second ring electronic device 20, information regarding the output state of the first projection screen. For example, the first ring electronic device 10 may transmit, to the second ring electronic device 20, the information regarding the output state of the first projection screen as a part of the request signal for the unified projection screen. The information regarding the output state of the first projection screen may include whether the first projection screen is a home screen. For example, the first ring electronic device 10 may transmit the information regarding the output state of the first projection screen to the second ring electronic device 20, similar to operation 530-1 of FIG. 5A in which the second ring electronic device 20 transmits, to the first ring electronic device 10, the information regarding the output state of the second projection screen.

According to an embodiment, the second ring electronic device 20 may generate the screen for the expanded user interface corresponding to the content of the second ring electronic device 20, for example, the execution screen of the second application, based on the request signal for the unified projection screen and the information regarding the output state of the first projection screen. The second ring electronic device 20 may generate the screen by rendering the image signal for the expanded user interface. The second ring electronic device 20 may split the screen for the expanded user interface into a part and another part to generate a first part and a second part. The second ring electronic device 20 may transmit information regarding the first part to the first ring electronic device 10. The first ring electronic device 10 may control the projection circuitry to output the first part as the first partial screen 6010. The second ring electronic device 20 may control the projection circuitry to output the second part as the second partial screen 6020.

According to an embodiment, the second ring electronic device 20 may generate the image signal of the first part and the image signal of the second part of the screen for the expanded user interface corresponding to the content of the second ring electronic device 20, based on the request signal for the unified projection screen and the information regarding the output state of the first projection screen. Using the projection circuitry, the second ring electronic device 20 may generate the second part by rendering the image signal of the second part. The second ring electronic device 20 may transmit the information regarding the image signal of the first part to the first ring electronic device 10. The first ring electronic device 10 may generate the first part by rendering the image signal of the first part. The first ring electronic device 10 may control the projection circuitry to output the first part as the first partial screen 6010. The second ring electronic device 20 may control the projection circuitry to output the second part as the second partial screen 6020.

For example, when the second trigger motion for the unified projection screen is detected while a plurality of ring electronic devices outputs projection screens for user interfaces corresponding to a home screen, the first part and the second part of the screen for the expanded user interface of the home screen may be output as the first partial screen 6010 and the second partial screen 6020, respectively.

For example, when the second trigger motion for the unified projection screen is detected while the first projection screen 601 and the second projection screen 602 are output as independent user interfaces, a screen for an expanded user interface corresponding to the content of a main ring electronic device may be generated. The first part and the second part of the screen for the expanded user interface may be output as the first partial screen 6010 and the second partial screen 6020, respectively. That is, a ring electronic device (hereinafter, auxiliary ring electronic device) other than the main ring electronic device may be excluded when configuring the unified projection screen 6100. According to an embodiment, when the second trigger motion is detected while the auxiliary ring electronic device executes any application, the execution of the application may be stopped or the application may be executed in the background. One of the plurality of ring electronic devices may be set as the main ring electronic device. The main ring electronic device may be selected or changed by a user.

Hereinafter, a case in which the first ring electronic device 10 is the main ring electronic device is described in greater detail.

The first ring electronic device 10 may output the first projection screen 601 showing the execution screen of the first application. The second ring electronic device 20 may output the second projection screen 602 showing the execution screen of the second application. The first ring electronic device 10 may transmit a request signal for the unified projection screen to the second ring electronic device 20, based on detecting the second trigger motion. The request signal for the unified projection screen may include a request, command, or control signal to start the unified projection screen.

According to an embodiment, the request signal for the unified projection screen may further include any part of the screen for the expanded user interface. The first ring electronic device 10 may generate a screen by rendering an image signal for the expanded user interface corresponding to the execution screen of the first application. The first ring electronic device 10 may split the screen for the expanded user interface into a part and another part to generate a first part and a second part. The first ring electronic device 10 may transmit, to the second ring electronic device 20, the request signal for the unified projection screen including the second part.

According to an embodiment, the request signal for the unified projection screen may further include an image signal of any part of the screen for the expanded user interface. The first ring electronic device 10 may generate an image signal of a first part and an image signal of a second part of the screen for the expanded user interface corresponding to the content of the first ring electronic device 10. Using the projection circuitry, the first ring electronic device 10 may generate the first part by rendering the image signal of the first part. The first ring electronic device 10 may transmit, to the second ring electronic device 20, the request signal for the unified projection screen including the image signal of the second part. The second ring electronic device 20 may generate the second part by rendering the image signal of the second part based on the request signal for the unified projection screen.

The second ring electronic device 20 may stop the execution of the second application or execute the second application in the background in response to the request signal for the unified projection screen.

Hereinafter, a method of providing battery states of ring electronic devices is described in greater detail.

In state 610 of FIG. 6, the first ring electronic device 10 and the second ring electronic device 20 may independently output the first projection screen 601 and the second projection screen 602, respectively. The first projection screen 601 and the second projection screen 602 may include the battery state of the first ring electronic device 10 and the battery state of the second ring electronic device 20, respectively.

In state 630 of FIG. 6, the first ring electronic device 10 and the second ring electronic device 20 may output the first partial screen 6010 and the second partial screen 6020, respectively, for the unified projection screen 6100.

According to an embodiment, the first partial screen 6010 and the second partial screen 6020 may respectively display individual content of the first ring electronic device 10 and the second ring electronic device 20. That is, the first partial screen 6010 and the second partial screen 6020 may be independent user interfaces. The first partial screen 6010 and the second partial screen 6020 may include the battery state of the first ring electronic device 10 and the battery state of the second ring electronic device 20, respectively.

According to an embodiment, different parts of the unified projection screen 6100 for an expanded user interface corresponding to the same content may be output as the first partial screen 6010 and the second partial screen 6020. For example, the first partial screen 6010 and the second partial screen 6020 may form a unified interface. The unified projection screen 6100 may include the respective battery states of the first ring electronic device 10 and the second ring electronic device 20 together on one partial screen. For example, as illustrated in FIG. 6, the respective battery states of the first ring electronic device 10 and the second ring electronic device 20 may be displayed together on a partial screen (e.g., the first partial screen 6010) positioned at the top from the perspective of a user wearing the first ring electronic device 10 and the second ring electronic device 20.

FIG. 7 is a diagram illustrating an example operation of providing a split screen according to various example embodiments.

FIG. 7 illustrates states 710, 720 and 730 in which the first ring electronic device 10 (e.g., the electronic device 102 of FIG. 1 or the electronic device 200 of FIG. 2) and a second ring electronic device 20 (e.g., the electronic device 102 of FIG. 1 or the electronic device 200 of FIG. 2) are worn by a user. The first ring electronic device 10 and the second ring electronic device 20 may each include at least some of the components of the ring electronic device 200 described with reference to FIG. 2. For example, the first ring electronic device 10 and the second ring electronic device 20 may include at least one processor (e.g., the processor 210 of FIG. 2), memory (e.g., the memory 220 of FIG. 2), a communicator (e.g., the communicator 230 of FIG. 2), a camera (e.g., the camera 11 of FIG. 4), sensor circuitry, and a projection circuitry.

According to an embodiment, while being worn on the finger 4 of the user, the first ring electronic device 10 may continuously detect a motion using the camera. While being worn on the finger 5 of the user, the second ring electronic device 20 may continuously detect a motion using the camera. According to an embodiment, the second ring electronic device 20 may transmit information regarding a motion detected by the second ring electronic device 20 to the first ring electronic device 10.

In states 710 and 720, the first ring electronic device 10 may output a first partial screen 701 for a unified projection screen 7100. The second ring electronic device 20 may output a second partial screen 702 for the unified projection screen 7100. Referring to FIG. 7, the first ring electronic device 10 may output the first partial screen 701 for a user interface corresponding to the content of the first ring electronic device 10. The second ring electronic device 20 may output the second partial screen 702 for a user interface corresponding to the content of the second ring electronic device 20. For example, the first ring electronic device 10 may output the first partial screen 701 for a user interface corresponding to the execution screen of a first application. The second ring electronic device 20 may output the second partial screen 702 for a user interface corresponding to the execution screen of a second application.

According to an embodiment, the first ring electronic device 10 may generate a screen for an expanded user interface corresponding to the content of the first ring electronic device 10 based on detecting at least a part of a third trigger motion for expanding the user interface while the first partial screen 701 for the unified projection screen 7100 is output.

According to an embodiment, the third trigger motion for expanding the user interface may be a motion configured to trigger, initiate, or start the output of an expanded user interface corresponding to the same content across a plurality of ring electronic devices (e.g., the first ring electronic device 10 and the second ring electronic device 20). The third trigger motion may be preset or changed by a user.

According to an embodiment, the third trigger motion may be a swipe motion in which the second hand, on which the first ring electronic device 10 and the second ring electronic device 20 are not worn, swipes from any point on one partial screen of the first hand, on which the first ring electronic device 10 and the second ring electronic device 20 are worn, to any point on another partial screen. For example, the third trigger motion for the first partial screen 701 may be a motion of swiping from any point on the first partial screen 701 to any point on another partial screen (e.g., the second partial screen 702). For example, the third trigger motion for the second partial screen 702 may be a motion of swiping from any point on the second partial screen 702 to any point on another partial screen (e.g., the first partial screen 701).

According to an embodiment, the third trigger motion may be a motion in which the second hand spreads (or pinch-to-zoom) on any part of the screen displayed on the first hand. For example, the third trigger motion for the first partial screen 701 may be a motion in which the fingers of the second hand spread on the first partial screen 701.

In state 710, the first ring electronic device 10 may generate a screen for an expanded user interface corresponding to the content of the first ring electronic device 10 based on detecting at least a part of a motion of swiping from any point of the first partial screen 701 to any point of the second partial screen 702 while the first partial screen 701 for the unified projection screen 7100 is output.

In state 720, the first ring electronic device 10 may generate the screen for the expanded user interface corresponding to the content of the first ring electronic device 10 based on detecting at least a part of the motion in which the fingers of the second hand spread on the first partial screen 701 while the first partial screen 701 for the unified projection screen 7100 is output.

According to an embodiment, the first ring electronic device 10 may generate a screen by rendering an image signal for an expanded user interface corresponding to the content of the first ring electronic device 10, that is, the execution screen of the first application. The first ring electronic device 10 may split the screen for the expanded user interface into a part and another part to generate a first part 7010 and a second part 7020. The first ring electronic device 10 may transmit information regarding the second part 7020 to the second ring electronic device 20. The first ring electronic device 10 may control the projection circuitry to output the first part 7010 as the first partial screen 701. For example, the first ring electronic device 10 may output the first part 7010 in place of the first partial screen 701. The second ring electronic device 20 may control the projection circuitry to output the second part 7020 as the second partial screen 702 based on the information regarding the second part 7020. For example, the second ring electronic device 20 may output the second part 7020 in place of the second partial screen 702.

According to an embodiment, the first ring electronic device 10 may generate an image signal of the first part 7010 and an image signal of the second part 7020 of the expanded user interface corresponding to the execution screen of the first application. Using the projection circuitry, the first ring electronic device 10 may generate the first part 7010 by rendering the image signal of the first part 7010. The first ring electronic device 10 may transmit a request signal for the unified projection screen including the image signal of the second part 7020 to the second ring electronic device 20. The second ring electronic device 20 may generate the second part 7020 by rendering the image signal of the second part 7020 based on the request signal for the unified projection screen. The first ring electronic device 10 may control the projection circuitry to output the first part 7010 as the first partial screen 701. The second ring electronic device 20 may control the projection circuitry to output the second part 7020 as the second partial screen 702.

According to an embodiment, referring to FIG. 7, in states 710 and 720, the first ring electronic device 10 may output the first partial screen 701 for a user interface corresponding to the execution screen of a music application. Based on detecting at least a part of the third trigger motion for expanding the user interface, the first ring electronic device 10 may output the first part 7010 of the expanded user interface corresponding to the execution screen of the music application in state 730. In state 730, the second ring electronic device 20 may output the second part 7020 of the expanded user interface corresponding to the execution screen of the music application. For example, the first part 7010 may include information regarding the currently playing music, such as a title and a singer, and the second part 7020 may include control elements of the music application. However, the disclosure is not limited thereto.

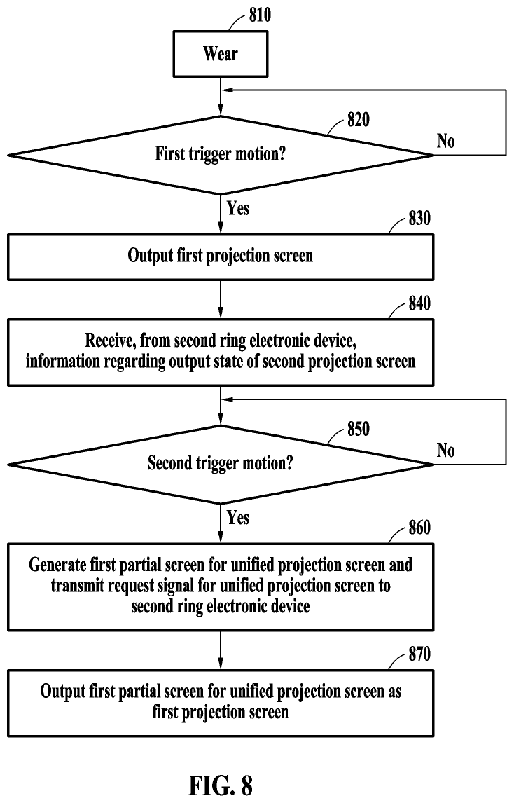

FIG. 8 is a flowchart illustrating an example method of providing a unified projection screen according to various example embodiments.

According to an embodiment, operations 810 to 880 below may be performed by a first ring electronic device (e.g., the electronic device 102 of FIG. 1, the ring electronic device 200 of FIG. 2, or the first ring electronic device 10 of FIGS. 4, 6, and 7). According to an embodiment, the flowchart illustrated in FIG. 8 may include example operations for implementing various embodiments of the present disclosure, and at least some of the operations included in the flowchart may be omitted, changed in order, or replaced with operations of other drawing(s). The first ring electronic device 10 may include at least some of the components of the ring electronic device 200 described with reference to FIG. 2. For example, the first ring electronic device may include at least one processor (e.g., the processor 210 of FIG. 2), memory (e.g., the memory 220 of FIG. 2), a communicator (e.g., the communicator 230 of FIG. 2), a camera (e.g., the camera 11 of FIG. 4), sensor circuitry, and a projection circuitry.

In operation 810, based on data received from the sensor circuitry, the first ring electronic device may identify that the first ring electronic device is worn on a finger of a user.

According to an embodiment, while being worn on the finger of the user, the first ring electronic device may detect a motion (or a motion input) using the camera. Using data received from the camera, the first ring electronic device may detect a motion of the user.

In operation 820, while being worn on the finger of the user, using the camera, the first ring electronic device may determine whether at least a part of a first trigger motion for a projection screen is detected. The first trigger motion may be a motion configured to trigger, initiate, or start the output of a first projection screen of the first ring electronic device. The first projection screen may be a screen that is output by the first ring electronic device. The first trigger motion may be predetermined or changed by the user.

In operation 830, based on detecting at least a part of the first trigger motion for the projection screen, the first ring electronic device may control the projection circuitry to output the first projection screen on a surface of the user.

In operation 840, the first ring electronic device may receive, from a second ring electronic device (e.g., the electronic device 102 of FIG. 1, the ring electronic device 200 of FIG. 2, or the second ring electronic device 20 of FIGS. 6 and 7), information regarding the output state of a second projection screen.

In operation 850, while the first projection screen and the second projection screen are output, using the data received from the camera, the first ring electronic device may determine whether at least a part of a second trigger motion for a unified projection screen of the first ring electronic device and the second ring electronic device is detected. The second trigger motion may be a motion configured to trigger, initiate, or start the output of a unified projection screen of a plurality of ring electronic devices (e.g., the first ring electronic device 10 and the second ring electronic device 20). The second trigger motion may be preset or changed by the user.

In operation 860, based on detecting at least a part of the second trigger motion, the first ring electronic device may generate a first partial screen for the unified projection screen and transmit a request signal for the unified projection screen to the second ring electronic device.

In operation 870, the first ring electronic device may control the projection circuitry to output the first partial screen for the unified projection screen as a first projection screen.

FIG. 9 is a diagram illustrating an example method of adjusting a screen according to various example embodiments.

According to an embodiment, a ring electronic device 9 (e.g., the electronic device 102 of FIG. 1, the ring electronic device 200 of FIG. 2, the first ring electronic device of FIGS. 3 to 7, or the second ring electronic device 20 of FIGS. 5a to 7) may output a screen 90. According to an embodiment, the screen 90 may be one of the projection screens (e.g., a first projection screen or a second projection screen) or the partial screens (e.g., a first partial screen or a second partial screen) for a unified projection screen described above.

According to an embodiment, the screen 90 may have a left side (or edge) 91, a right side 92, a near side 93, and a far side 94. Referring to FIG. 9, with respect to the ring electronic device 9 that outputs the screen 90, the left side 91 and the right side 92 may each represent the longitudinal side where the screen 90 is output. The near side 93 and the far side 94 may each represent a side in the width direction of the screen 90. The near side 93 may represent the side relatively close to the ring electronic device 9. The far side 94 may represent the side relatively far from the ring electronic device 9.

According to an embodiment, the ring electronic device 9 may control the projection circuitry to adjust the length of at least one of the left side 91, the right side 92, the near side 93, or the far side 94 of the screen 90.

For example, referring to (a) in FIG. 9, the length of the screen 90 between the near side 93 and the far side 94 of the screen 90 may be adjusted. According to an embodiment, the lengths of the left side 91 and the right side 92 may be adjusted differently to correct distortion of the screen 90 that is output.

For example, the width (or length of the width) of the screen 90 between the left side 91 and the right side 92 of the screen 90 may be adjusted. According to an embodiment, the lengths of the near side 93 and the far side 94 may be adjusted differently to correct distortion of the screen 90 that is output.

According to an embodiment, the ring electronic device 9 may control the projection circuitry to adjust the position of the screen 90. Referring to (b) of FIG. 9, the relative position of the screen 90 with respect to a point corresponding to the optical axis through which the screen 90 is output (or projected) via a projection lens (e.g., the projection lens 15 of FIG. 4) may be adjusted. At least some of the distances from the sides of the screen 90 to the point corresponding to the optical axis may be changed. For example, when the screen 90 is positioned in the direction away from the ring electronic device 9, the distance from the left side 91 and the right side 92 to the point corresponding to the optical axis may be maintained.

According to an embodiment, the ring electronic device 9 may control the projection circuitry to adjust the rotation angle of the screen 90. Referring to (c) of FIG. 9, the screen 90 may rotate clockwise or counterclockwise based on the point corresponding to the optical axis where the screen 90 is output. Each distance from each side of the screen 90 to the point corresponding to the optical axis may be maintained.

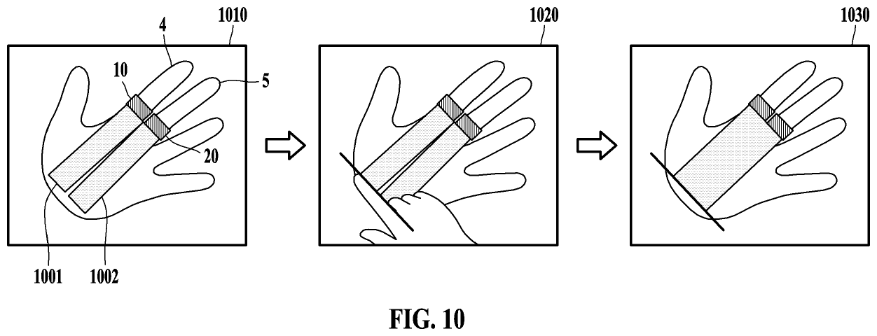

FIG. 10 is a diagram illustrating an example operation of aligning a projection screen according to various example embodiments.

FIG. 10 illustrates states 1010 to 1030 in which the first ring electronic device 10 (e.g., the electronic device 102 of FIG. 1 or the ring electronic device 200 of FIG. 2) and the second ring electronic device 20 (e.g., the electronic device 102 of FIG. 1 or the ring electronic device 200 of FIG. 2) are worn by a user. The first ring electronic device 10 and the second ring electronic device 20 may each include at least some of the components of the ring electronic device 200 described with reference to FIG. 2. For example, the first ring electronic device 10 and the second ring electronic device 20 may include at least one processor (e.g., the processor 210 of FIG. 2), memory (e.g., the memory 220 of FIG. 2), a communicator (e.g., the communicator 230 of FIG. 2), a camera (e.g., the camera 11 of FIG. 4), sensor circuitry, and a projection circuitry.

According to an embodiment, while being worn on the finger 4 of a user, the first ring electronic device 10 may continuously detect a motion using the camera. While being worn on the finger 5 of the user, the second ring electronic device 20 may continuously detect the motion using the camera.

In state 1010, the first ring electronic device 10 may output a screen 1001. The second ring electronic device 20 may output a screen 1002. According to an embodiment, the screen 1001 may be one of the first projection screen or the first partial screen for the unified projection screen described above. The screen 1002 may be one of the second projection screen or the second partial screen for the unified projection screen described above.

According to an embodiment, the screen 1001 and the screen 1002 may each include a left side, a right side, a near side, and a far side.

According to an embodiment, state 1010 may be an unaligned state in which the size (or length) of the screen 1001 and/or the screen 1002 is not the same as that of the other one.

According to an embodiment, state 1010 may be an unaligned state in which the positions at which the screen 1001 and the screen 1022 (e.g., the positions of the near sides of the screen 1001 and/or the screen 1002) are output are not the same as each other.

According to an embodiment, state 1010 may be an unaligned state in which the output directions, angles, or the like of the screen 1001 and/or the screen 1002 are not same as each other, as illustrated in FIG. 10.

In state 1020, while the screen 1001 and the screen 1002 (e.g., the first projection screen and the second projection screen) are output, using data received from the camera, the first ring electronic device 10 may detect at least a part of an alignment motion for the screen 1001 and the screen 1002.

According to an embodiment, the alignment motion may be a motion in which a second hand of a user, on which the first ring electronic device 10 and the second ring electronic device 20 are not worn, indicates an alignment line to the first hand on which the first ring electronic device 10 and the second ring electronic device 20 are worn. For example, the alignment motion may be a motion in which extended fingers (e.g., a single finger or multiple fingers) of the second hand are positioned over the first hand so as to face a desired alignment line and are maintained for a predetermined time (e.g., 1 to 2 seconds). For example, the alignment motion may be a motion in which the edge of the second hand is positioned over the first hand so as to face a desired alignment line and is maintained for a predetermined time.

According to an embodiment, using the camera (or sensor) described with reference to FIG. 2, the first ring electronic device 10 may measure the distance from the first ring electronic device 10 (or the camera of the first ring electronic device 10) to the second hand or the fingers of the second hand (hereinafter, second hand) of the user. Using the camera, the first ring electronic device 10 may continuously monitor the distance to the second hand.

According to an embodiment, based on the distance to the second hand, the first ring electronic device 10 may detect the alignment motion. For example, the first ring electronic device 10 may detect the alignment motion when a state in which the distance from the first ring electronic device 10 to the second hand is measured as a designated distance (e.g., the length of the screen 1001) or within an error range of the designated distance is maintained for a predetermined time.

According to an embodiment, the first ring electronic device 10 may receive, from the second ring electronic device 20, information regarding a motion detected using the camera of the second ring electronic device 20. The first ring electronic device 10 may receive, from the second ring electronic device 20, information regarding the distance from the second ring electronic device 20 (or the camera of the second ring electronic device 20) to the second hand or the fingers of the second hand (hereinafter, second hand) of the user. The first ring electronic device 10 may detect the alignment motion when the distance from the first ring electronic device 10 to the second hand is the same as or similar to the distance from the second ring electronic device 20 to the second hand. For example, the first ring electronic device 10 may detect the alignment motion when the distance from the first ring electronic device 10 to the second hand is the same as or similar to the distance from the second ring electronic device 20 to the second hand and when a state in which a distance is measured as a designated distance or within an error range of the designated distance is maintained for a predetermined time.

In state 1030, based on detecting at least a part of the alignment motion for the screen 1001 and the screen 1002, the first ring electronic device 10 may control the projection circuitry to adjust the output of the screen 1001. For example, as described above with reference to FIG. 2, the first ring electronic device 10 may control the projection circuitry to perform a function such as zoom, keystone, and lens shift.

According to an embodiment, the first ring electronic device 10 may control the projection circuitry to adjust the length of the screen 1001 between the near side and the far side of the screen 1001 so that the far side of the screen 1001 reaches the alignment line indicated by the alignment motion.

According to an embodiment, the first ring electronic device 10 may control the projection circuitry to adjust the position of the screen 1001 so that the far side of the screen 1001 reaches the alignment line indicated by the alignment motion.

According to an embodiment, the first ring electronic device 10 may control the projection circuitry to adjust the rotation angle of the screen 1001 so that the far side of the screen 1001 reaches the alignment line indicated by the alignment motion.

According to an embodiment, the first ring electronic device 10 may transmit a signal requesting alignment of the screen 1002 to the second ring electronic device 20. For example, as described above with reference to FIG. 2, using the projection circuitry, the second ring electronic device 20 may control the projection circuitry to perform a function such as zoom, keystone, and lens shift. Based on the alignment request signal, the second ring electronic device 20 may control the projection circuitry to adjust the output of the screen 1002.

According to an embodiment, in state 1010, the first ring electronic device 10 may determine the alignment state of the screen 1001 and the screen 1002. For example, using the camera, the first ring electronic device 10 may monitor the alignment state of the screen 1001 and the screen 1002. According to an embodiment, the first ring electronic device 10 may control the projection circuitry to perform a function such as zoom, keystone, and lens shift without detecting the alignment motion (e.g., skipping state 1020). The first ring electronic device 10 may transmit a signal requesting alignment of the screen 1002 to the second ring electronic device 20.

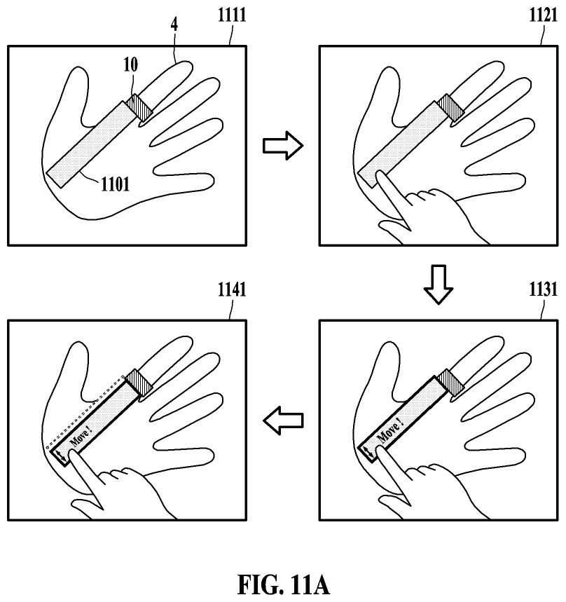

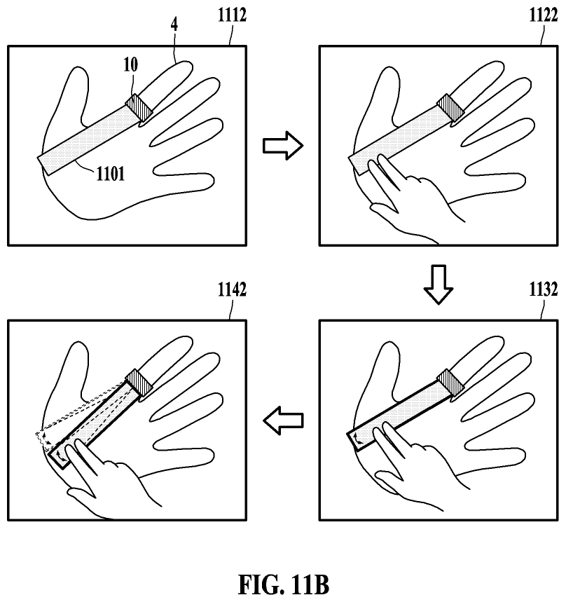

FIGS. 11A and 11B are diagrams illustrating an example operation of adjusting an output of a projection screen according to various example embodiments.

FIGS. 11A and 11B illustrate states 1111 to 1141 and 1112 to 1142 in which the first ring electronic device 10 (e.g., the electronic device 102 of FIG. 1 or the ring electronic device 200 of FIG. 2) is worn by a user. The first ring electronic device 10 may include at least some of the components of the ring electronic device 200 described with reference to FIG. 2. For example, the first ring electronic device 10 may include at least one processor (e.g., the processor 210 of FIG. 2), memory (e.g., the memory 220 of FIG. 2), a communicator (e.g., the communicator 230 of FIG. 2), a camera (e.g., the camera 11 of FIG. 4), sensor circuitry, and a projection circuitry.

According to an embodiment, while being worn on the finger 4 of the user, the first ring electronic device 10 may continuously detect a motion using the camera.

FIG. 11A is a diagram illustrating an example operation of adjusting the position of the screen 1001 that is output by the first ring electronic device 10.

In state 1111, the first ring electronic device 10 may output the screen 1001. According to an embodiment, a screen 1101 may be either the first projection screen or the first partial screen for the unified projection screen described above.

According to an embodiment, state 1111 may be a state in which the screen 1101 is not output on a proper position, as illustrated in FIG. 11A.

In state 1121, the first ring electronic device 10 may detect at least a part of an adjustment motion for the screen 1101 using data received from the camera while the screen 1101 is output. For example, the first ring electronic device 10 may detect at least a part of a press-and-hold motion of a single finger (e.g., a single finger of the second hand on which the first ring electronic device 10 is not worn). The first ring electronic device 10 may detect a motion in which a single finger touches any point on the screen 1001 and maintain contact for a predetermined time (e.g., 1 to 3 seconds).

In state 1131, the first ring electronic device 10 may activate the adjustment state of the screen 1101 based on detecting the press-and-hold motion of the single finger for the screen 1101. For example, the first ring electronic device 10 may output the screen 1001 including a message instructing to adjust the position of the screen 1101.

In state 1141, the first ring electronic device 10 may control the projection circuitry to adjust the position of the screen 1101 based on a motion of the user detected while the adjustment state is activated. Particularly, the position of the screen 1001 may be moved based on the direction of the motion of the single finger of the second hand.

FIG. 11B is a diagram illustrating an operation of adjusting the rotation angle of the screen 1101 that is output by the first ring electronic device 10.

In state 1112, the first ring electronic device 10 may output the screen 1101. According to an embodiment, the screen 1101 may be either the first projection screen or the first partial screen for the unified projection screen described above.

According to an embodiment, state 1112 may be a state in which the screen 1101 is not output at an appropriate angle, as shown in FIG. 11B.

In state 1122, the first ring electronic device 10 may detect at least a part of an adjustment motion for the screen 1101 using data received from the camera while the screen 1101 is output. For example, the first ring electronic device 10 may detect at least a part of a press-and-hold motion of multiple fingers (e.g., multiple fingers of the second hand on which the first ring electronic device 10 is not worn). The first ring electronic device 10 may detect a motion in which the multiple fingers touch any point on the screen 1101 and maintain contact for a predetermined time (e.g., 1 to 3 seconds).

In state 1132, the first ring electronic device 10 may activate the adjustment state of the screen 1101 based on detecting the press-and-hold motion of the multiple fingers for the screen 1101. For example, the first ring electronic device 10 may output the screen 1101 including a message instructing to adjust the angle of the screen 1101.

In state 1142, the first ring electronic device 10 may control the projection circuitry to adjust the rotation angle of the screen 1101 based on the motion of the user detected while the adjustment state is activated. For example, the rotation angle of the screen 1101 may be adjusted based on the direction of the motion of the multiple fingers of the second hand.

The correspondence between the adjustment motions described with reference to FIGS. 11A and 11B and the adjustment states for adjusting the position or rotation angle of the screen 1101 is not limited. For example, the rotation angle of a screen may be adjusted based on detection of a press-and-hold motion of a single finger for the screen, or the position of the screen may be adjusted based on detection of a press-and-hold motion of multiple fingers. For example, the type of adjustment motion to be detected (a press-and-hold motion of a single finger or multiple fingers) and, correspondingly, the type of a target that is adjusted while the adjustment state is activated may be changed according to user settings or implemented in various ways based on manufacturer configurations.

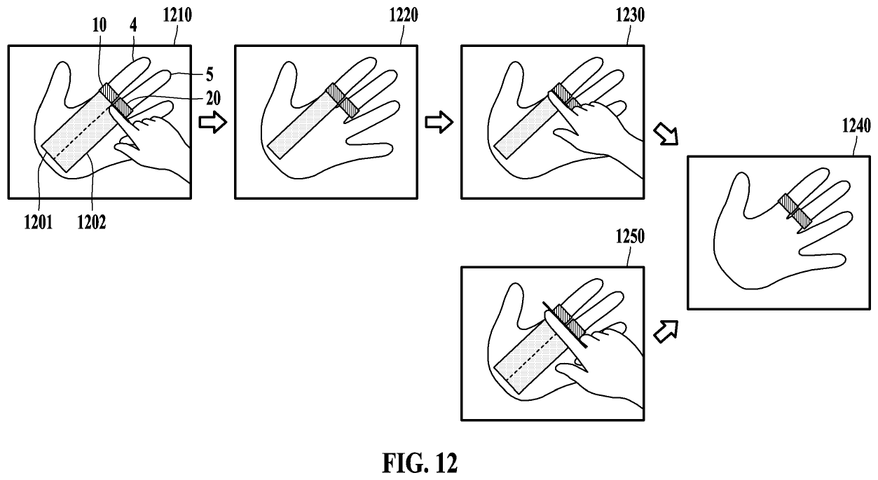

FIG. 12 is a diagram illustrating an example operation of stopping outputting a projection screen according to various example embodiments.

FIG. 12 illustrates states 1210 to 1250 in which the first ring electronic device 10 (e.g., the electronic device 102 of FIG. 1 or the ring electronic device 200 of FIG. 2) and the second ring electronic device 20 (e.g., the electronic device 102 of FIG. 1 or the ring electronic device 200 of FIG. 2) are worn by a user. The first ring electronic device 10 and the second ring electronic device 20 may include at least some of the components of the ring electronic device 200 described with reference to FIG. 2. For example, the first ring electronic device 10 and the second ring electronic device 20 may include at least one processor (e.g., the processor 210 of FIG. 2), memory (e.g., the memory 220 of FIG. 2), a communicator (e.g., the communicator 230 of FIG. 2), a camera (e.g., the camera 11 of FIG. 4), sensor circuitry, and a projection circuitry.

According to an embodiment, while being worn on the finger 4 of the user, the first ring electronic device 10 may continuously detect a motion using the camera. While being worn on the finger 5 of the user, the second ring electronic device 20 may continuously detect the motion using the camera.

In states 1210 and 1250, the first ring electronic device 10 may output a screen 1201. The second ring electronic device 20 may output a screen 1202. According to an embodiment, the screen 1201 may be either the first projection screen or the first partial screen for the unified projection screen described above. The screen 1202 may be either the second projection screen or the second partial screen for the unified projection screen described above.

In state 1210, the second ring electronic device 20 may detect at least a part of a shut-down motion for the screen 1202 using data received from the camera (or sensor) while the screen 1202 is output.

According to an embodiment, the shut-down motion may be a motion in which the second hand, on which the ring electronic device (e.g., the first ring electronic device 10 or the second ring electronic device 20) is not worn, touches (or presses) and holds the ring electronic device.

According to an embodiment, the shut-down motion may be a motion in which the body of a user or any object covers or blocks the output of a screen (e.g., the screen 1201 or the screen 1202) of the ring electronic device.

According to an embodiment, the shut-down motion may be a motion in which the first hand on which the ring electronic device is worn makes a fist.

According to an embodiment, the shut-down motion may be any motion that places the first hand in a state in which normal screen output or user viewing of the screen is not possible. For example, the shut-down motion may include motions such as placing the first hand in a pocket, lowering the first hand in the direction of gravitational acceleration, or using the first hand to support the body against the ground.

In state 1220, the second ring electronic device 20 may control the projection circuitry to stop outputting the screen 1202 based on detecting at least a part of the shut-down motion for the screen 1202. According to an embodiment, when the screens 1201 and 1202 are output as partial screens for a unified projection screen in state 1210, the provision of the unified projection screen may be terminated by stopping outputting the screen 1202. According to an embodiment, the first ring electronic device 10 may generate a new screen 1201 and output the new screen 1201 in state 1220. For example, the first ring electronic device 10 may generate and output the screen 1201 for a user interface corresponding to the execution screen of an application running in state 1210. For example, the first ring electronic device 10 may generate and output the screen 1201 for a user interface corresponding to a home screen.

In state 1230, the first ring electronic device 10 may detect at least a part of a shut-down motion for the screen 1201 using data received from the camera while the screen 1201 is output.

In state 1240, the first ring electronic device 10 may control the projection circuitry to stop outputting the screen 1201 based on detecting at least a part of the shut-down motion for the screen 1201 in state 1230.

In state 1250, the first ring electronic device 10 may detect a shut-down motion for the screen 1201 and the screen 1202 using data received from the camera while the screen 1201 and the screen 1202 are output. Additionally or optionally, the second ring electronic device 20 may detect a shut-down motion for the screen 1202 using data received from the camera while the screen 1201 and the screen 1202 are output.

According to an embodiment, the first ring electronic device 10 may receive, from the second ring electronic device 20, information regarding a motion detected using the camera of the second ring electronic device 20. The first ring electronic device 10 may detect a shut-down motion for the screen 1201 and the screen 1202 based on information regarding a motion detected by the first ring electronic device 10 and a motion received from the second ring electronic device 20.

In state 1240, the first ring electronic device 10 may control the projection circuitry to stop outputting the screen 1201 based on detecting at least a part of the shut-down motion for the screen 1201 and the screen 1202 in state 1250. According to an embodiment, the first ring electronic device 10 may transmit a request signal to the second ring electronic device 20 to stop outputting the screen 1202, and the second ring electronic device 20 may control the projection circuitry to stop outputting the screen 1202 based on the request signal. That is, the second ring electronic device 20 may stop outputting the screen 1202 based on directly detecting a shut-down motion for the screen 1202 according to an embodiment or based on the request signal to stop outputting the screen 1202.

According to an embodiment, the first ring electronic device 10 may stop outputting the screen 1201 in various cases. According to an embodiment, the first ring electronic device 10 may control the projection circuitry to stop outputting the screen 1201 when a predetermined state condition is satisfied.

For example, the first ring electronic device 10 may control the projection circuitry to stop outputting the screen 1201 when no motion of the user is detected for a threshold time.

For example, the first ring electronic device 10 may stop outputting the screen 1201 based on data received from an external electronic device (e.g., the electronic device 101 of FIG. 1 or the external electronic device 50 of FIGS. 5b and 5c) connected to the first ring electronic device 10. The first ring electronic device 10 may control the projection circuitry to stop outputting the screen 1201 in response to receiving, from the external electronic device, information regarding a state in which the external electronic device is being used by the user. The first ring electronic device 10 may control the projection circuitry to stop outputting the screen 1201 in response to receiving, from the external electronic device, a state indicating that the external electronic device is picked up by the user.

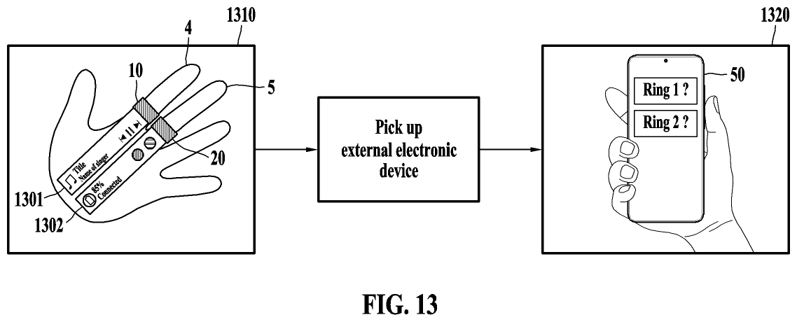

FIG. 13 is a diagram illustrating an example operation associated with an external electronic device according to various example embodiments.

FIG. 13 illustrates state 1310 in which the first ring electronic device 10 (e.g., the electronic device 102 of FIG. 1 or the ring electronic device 200 of FIG. 2) and the second ring electronic device 20 (e.g., the electronic device 102 of FIG. 1 or the ring electronic device 200 of FIG. 2) are worn by a user and state 1320 of the external electronic device 50 (e.g., the electronic device 101 of FIG. 1) connected to the first ring electronic device 10 and/or the second ring electronic device 20. The first ring electronic device 10 and the second ring electronic device 20 may each include at least some of the components of the ring electronic device 200 described with reference to FIG. 2. For example, the first ring electronic device 10 and the second ring electronic device 20 may include at least one processor (e.g., the processor 210 of FIG. 2), memory (e.g., the memory 220 of FIG. 2), a communicator (e.g., the communicator 230 of FIG. 2), a camera (e.g., the camera 11 of FIG. 4), sensor circuitry, and a projection circuitry.

In state 1310, the first ring electronic device 10 may output a screen 1301. The second ring electronic device 20 may output a screen 1302. According to an embodiment, the screen 1301 may be either the first projection screen or the first partial screen for the unified projection screen described above. The screen 1302 may be either the second projection screen or the first partial screen for the unified projection screen described above.

According to an embodiment, while the screen 1301 is output, the first ring electronic device 10 may receive, from the external electronic device 50 connected to the first ring electronic device 10, a state (or information regarding a state indicating that the external electronic device 50 is picked up) indicating that the external electronic device 50 is picked up. For example, the external electronic device 50 may sense the state when the user picks up the external electronic device 50 using a sensor (e.g., an inertial sensor) of the external electronic device 50. The external electronic device 50 may transmit, to the first ring electronic device 10, the state indicating that the external electronic device 50 is picked up.

According to an embodiment, the first ring electronic device 10 may transmit information regarding the screen 1301 to the external electronic device 50 in response to receiving, from the external electronic device 50, the state indicating that the external electronic device 50 is picked up while the screen 1301 is output. The first ring electronic device 10 may transmit the information regarding a user interface corresponding to the screen 1301 to the external electronic device 50. According to an embodiment, the first ring electronic device 10 may transmit the information regarding the screen 1302 of the second ring electronic device 20 (or information regarding a user interface corresponding to the screen 1302) to the external electronic device 50. According to an embodiment, the second ring electronic device 20 may transmit the information regarding the screen 1302 to the external electronic device 50.

According to an embodiment, the screen projection of the first ring electronic device 10 and the second ring electronic device 20 may be controlled by the external electronic device 50. According to an embodiment, the screen projection of the second ring electronic device 20 may be controlled by the first ring electronic device 10. In various implementations, some operations may be omitted for simplicity and efficiency. For example, an operation in which the first ring electronic device 10 transmits the information regarding the screen 1301 and/or an operation in which the second ring electronic device 20 transmits the information regarding the screen 1302 may be skipped.

In state 1320, when the user picks up the external electronic device 50, the external electronic device 50 may output information regarding the ring electronic device (e.g., the first ring electronic device 10 or the second ring electronic device 20) that is outputting a screen (e.g., the screen 1301 or the screen 1302) through a display (e.g., the display module 160 of FIG. 1). For example, when screens are respectively output by a plurality of ring electronic devices, the external electronic device 50 may provide an interface for selecting which ring electronic device's screen (or content) to display. For example, the external electronic device 50 may provide an interface for determining whether to display the screen of a ring electronic device that is outputting a screen.

According to an embodiment, while the screen 1301 and the screen 1302 are output, the user may select to display at least some of the screens of the first ring electronic device 10 and the second ring electronic device 20 through the display of the external electronic device 50. The external electronic device 50 may receive information regarding the screen 1301 and/or the screen 1302 from the first ring electronic device 10 and/or the second ring electronic device 20 based on a selection (or a selection input) of the user.

According to an embodiment, the external electronic device 50 may output a first screen 1301 and a second screen 1302 through the display. For example, when the first screen 1301 and the second screen 1302 are output as independent first and second projection screens, respectively, the external electronic device 50 may output the first screen 1301 and the second screen 1302 individually. For example, when the first screen 1301 and the second screen 1302 are output as a first partial screen and a second partial screen, respectively, for a unified projection screen, the external electronic device 50 may output the unified projection screen.

According to an embodiment, the first ring electronic device 10 may control the projection circuitry to stop outputting the screen 1301 in response to receiving, from the external electronic device 50, the state indicating that the external electronic device 50 is picked up.

Hereinafter, a method of providing battery states of ring electronic devices is described in greater detail.

According to an embodiment, the external electronic device 50 may output, through the display, at least one of the first screen 1301 and the second screen 1302, excluding the battery state of the first ring electronic device 10 and the battery state of the second ring electronic device 20.

According to an embodiment, the external electronic device 50 may output the first screen 1301 including the battery state of the first ring electronic device 10 and the second screen 1302 including the battery state of the second ring electronic device 20.

According to an embodiment, the external electronic device 50 may output a unified projection screen that includes the battery states of the first ring electronic device 10 and the second ring electronic device 20 together on one partial screen.

According to an embodiment, when outputting only the first screen 1301, the external electronic device 50 may output the battery state of the first ring electronic device 10.

According to an embodiment, when outputting only the second screen 1302, the external electronic device 50 may output the battery state of the second ring electronic device 20.

FIG. 14 is a diagram illustrating an example user interface corresponding to a task associated with a ring electronic device, according to various example embodiments.

FIG. 14 illustrates states 1410 to 1440 in which the first ring electronic device 10 (e.g., the electronic device 102 of FIG. 1 or the ring electronic device 200 of FIG. 2) is worn by a user. The first ring electronic device 10 may include at least some of the components of the ring electronic device 200 described with reference to FIG. 2. For example, the first ring electronic device 10 may include at least one processor (e.g., the processor 210 of FIG. 2), memory (e.g., the memory 220 of FIG. 2), a communicator (e.g., the communicator 230 of FIG. 2), a camera (e.g., the camera 11 of FIG. 4), sensor circuitry, and a projection circuitry.

In state 1410, the first ring electronic device 10 may identify what is worn on the finger 4 of a user based on data received from the sensor circuitry. While being worn on the finger 4 of the user, the first ring electronic device 10 may detect a motion using the camera. Referring to FIG. 14, a gesture (or posture) in which the fingers of a first hand on which the first ring electronic device 10 is worn are spread is shown. However, the disclosure is not limited thereto. For example, in state 1410, a gesture of the first hand may be any gesture, such as making a fist or bending or extending some fingers.

According to an embodiment, in state 1410, the first ring electronic device 10 may detect a task (or occurrence of a task) associated with the first ring electronic device 10.

According to an embodiment, the first ring electronic device 10 may receive a task (or information regarding the task) associated with the first ring electronic device 10 from an external electronic device (e.g., the electronic device 101 of FIG. 1 or the external electronic device 50 of FIGS. 5B, 5C, or 13) connected to the first ring electronic device 10.

According to an embodiment, the first ring electronic device 10 may directly detect the occurrence of the task associated with the first ring electronic device 10 through a communicator (e.g., the communicator 230 of FIG. 2). For example, the first ring electronic device 10 may detect the occurrence of the task associated with the first ring electronic device 10 through cellular communication.

According to an embodiment, the first ring electronic device 10 may detect a task associated with an application included in the first ring electronic device 10. For example, the first ring electronic device 10 may detect a task associated with an application such as a media application (e.g., a music applications or a video streaming application), a fitness application, a messenger application, a call application, or an application linked to the external electronic device connected to the first ring electronic device 10. However, the disclosure is not limited thereto.

According to an embodiment, the first ring electronic device 10 may output feedback based on detecting the occurrence of the task associated with the first ring electronic device 10. For example, the first ring electronic device 10 may output haptic feedback.

According to an embodiment, the first ring electronic device 10 may output a first projection screen for a user interface corresponding to the task based on detecting at least a part of a first trigger motion. The first projection screen may be determined based on the detected task. The first projection screen may include, but is not limited to, screens 1401 to 1403.

According to an embodiment, in state 1420, a task may be associated with payment. For example, the task may be receiving a payment signal (or a payment request signal) via the communicator. The first ring electronic device 10 may generate and output the screen 1401 for a user interface associated with payment based on detecting at least a part of the first trigger motion. For example, the screen 1401 may include a user interface for the user to enter a password (e.g., a personal identification number (PIN), etc.) for payment. The user may enter a password through a touch motion for the screen 1401. According to an embodiment, the first ring electronic device 10 may perform payment by detecting the touch motion for the screen 1401. According to an embodiment, the first ring electronic device 10 may transmit, to the external electronic device, determined information (e.g., password entered by the user or whether payment is approved) by detecting the touch motion for the screen 1401.

According to an embodiment, in state 1430, the task may be associated with a call connection. For example, the task may be receiving a call signal through the communicator. The first ring electronic device 10 may generate and output the screen 1402 for a user interface associated with the transmission and reception of a call based on detecting at least a part of the first trigger motion. For example, the screen 1402 may include a user interface for the user to accept or reject a call connection. The first ring electronic device 10 may initiate or block a call connection by detecting a touch motion for the screen 1402. According to an embodiment, the first ring electronic device 10 may support a call connection function using an audio module that may convert sound into an electrical signal or, conversely, covert an electrical signal into sound. The first ring electronic device 10 may output sound through a sound output module or an external electronic device (e.g., the electronic device 101 of FIG. 1, the external electronic device 50 of FIGS. 5B, 5C, or 13, a speaker, or headphones) connected to the first ring electronic device 10. According to an embodiment, the first ring electronic device 10 may transmit a call connection initiation signal to the external electronic device. The external electronic device may initiate a call connection based on the call connection initiation signal.

According to an embodiment, in state 1440, the task may be associated with exercise. For example, the task may be a user completing exercise. Using a biometric sensor (e.g., the biometric sensor 250 of FIG. 2), the first ring electronic device 10 may obtain biometric information while the user is exercising. The first ring electronic device 10 may generate and output the screen 1403 for a user interface associated with exercise based on detecting at least a part of the first trigger motion. For example, the screen 1403 may include an exercise result based on biometric information of the user provided by a fitness application.

According to an embodiment, the task may be associated with sleep. For example, the task may be the user completing sleep. Using the biometric sensor, the first ring electronic device 10 may obtain biometric information while the user is sleeping. The first ring electronic device 10 may generate and output a screen including a sleep result, for example, based on detecting at least a part of the first trigger motion.

According to an embodiment, the task may be a push notification of an application. For example, the task may be a notification from an arbitrary application, such as receipt of a message or a payment completion state. The first ring electronic device 10 may generate and output a screen including a notification, such as a message preview and a payment completion state, based on detecting at least a part of the first trigger motion.

According to an embodiment, the task may be an execution state of an application. For example, the task may be an execution state of an application running on the first ring electronic device 10, such as a music playback state via a music application or an exercise state via a fitness application (or detection of biometric information resulting from exercise). The first ring electronic device 10 may generate and output a screen for a user interface for an execution screen of a music application, for example, based on detecting at least a part of the first trigger motion.

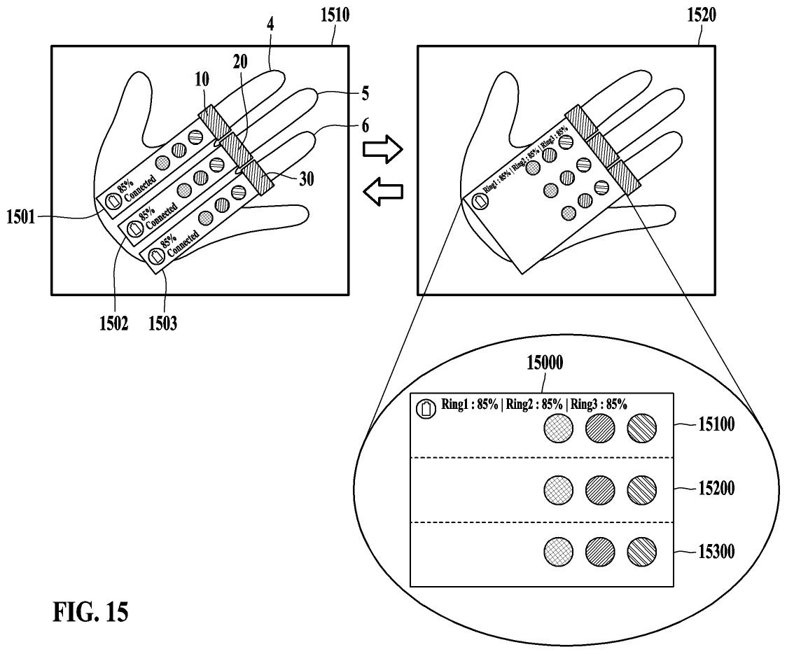

FIG. 15 is a diagram illustrating an example operation of providing a projection screen according to various example embodiments.

FIG. 15 illustrates states 1510 and 1520 in which the first ring electronic device 10 (e.g., the electronic device 102 of FIG. 1 or the ring electronic device 200 of FIG. 2), the second ring electronic device 20 (e.g., the electronic device 102 of FIG. 1 or the ring electronic device 200 of FIG. 2), and the third ring electronic device 30 (e.g., the electronic device 102 of FIG. 1 or the ring electronic device 200 of FIG. 2) are worn by a user. The third ring electronic device 30 may include at least some of the components of the ring electronic device 200 described with reference to FIG. 2. For example, the third ring electronic device 30 may include at least one processor (e.g., the processor 210 of FIG. 2), memory (e.g., the memory 220 of FIG. 2), a communicator (e.g., the communicator 230 of FIG. 2), a camera (e.g., the camera 11 of FIG. 4), sensor circuitry, and a projection circuitry.

According to an embodiment, the description of the first ring electronic device 10 or the second ring electronic device 20 may also apply to the third ring electronic device 30. In the present disclosure, for ease of description, elements (e.g., a projection screen, a partial screen, etc.) associated with the first ring electronic device 10 are referred to as “first-,” elements associated with the second ring electronic device 20 are referred to as “second-,” and elements associated with the third ring electronic device 30 are referred to as “third-.”

According to an embodiment, while being worn on the finger 4 of the user, the first ring electronic device 10 may continuously detect a motion using the camera. While being worn on the finger 5 of the user, the second ring electronic device 20 may continuously detect the motion using the camera. While being worn on a finger 6 of the user, the third ring electronic device 30 may continuously detect the motion using the camera.

In state 1510, the first ring electronic device 10 may output a first projection screen 1501. The second ring electronic device 20 may output a second projection screen 1502. The third ring electronic device 30 may output a third projection screen 1503.

According to an embodiment, the first ring electronic device 10 may receive, from the second ring electronic device 20 and the third ring electronic device 30, information regarding the output state of the second projection screen 1502 and the output state of the third projection screen 1503. While the first projection screen 1501, the second projection screen 1502, and the third projection screen 1503 are output, the first ring electronic device 10 may determine whether at least a part of a second trigger motion for a unified projection screen is detected.

According to an embodiment, the first ring electronic device 10 may receive, from the second ring electronic device 20 and the third ring electronic device 30, information regarding the output states of the second projection screen 1502 and the third projection screen 1503, information regarding a motion detected by the second ring electronic device 20, and information regarding a motion detected by the third ring electronic device 30. While the first projection screen 1501, the second projection screen 1502, and the third projection screen 1503 are output, based on the received information, the first ring electronic device 10 may determine whether at least a part of the second trigger motion for the unified projection screen is detected.

According to an embodiment, the first ring electronic device 10 may detect at least a part of the second trigger motion.

According to an embodiment, based on detecting at least a part of the second trigger motion, the first ring electronic device 10 may generate a first partial screen 15100 for a unified projection screen 15000 and transmit a request signal for a unified projection screen to the second ring electronic device 20 and the third ring electronic device 30. Based on the request signal for the unified projection screen, the second ring electronic device 20 and the third ring electronic device 30 may generate a second partial screen 15200 and a third partial screen 15300 for the unified projection screen 15000.

In state 1520, the first ring electronic device 10 may output, as the first projection screen 1501, the first partial screen 15100 for the unified projection screen 15000. The second ring electronic device 20 may output, as the second projection screen 1502, the second partial screen 15200 for the unified projection screen 15000. The third ring electronic device 30 may output, as the third projection screen 1503, the third partial screen 15300 for the unified projection screen 15000.

According to an embodiment, referring to FIG. 15, the unified projection screen 15000 may include the first partial screen 15100, the second partial screen 15200, and the third partial screen 15300. The unified projection screen 15000 may include the first partial screen 15100, the second partial screen 15200, and the third partial screen 15300 that are arranged consecutively. The first partial screen 15100, the second partial screen 15200, and the third partial screen 15300 may be arranged without gaps.

According to an embodiment, the description provided with reference to FIG. 6 may also apply to user interfaces of the unified projection screen 15000 and a plurality of partial screens (e.g., the first partial screen 15100, the second partial screen 15200, and the third partial screen 15300) included in the unified projection screen 15000, that is, the content included in the plurality of partial screens.

According to an embodiment, the first partial screen 15100, the second partial screen 15200, and the third partial screen 15300 of the unified projection screen 15000 may respectively display individual content of the first ring electronic device 10, the second ring electronic device 20, and the third ring electronic device 30.

For example, when the second trigger motion for the unified projection screen is detected while the first projection screen 1501, the second projection screen 1502, and the third projection screen 1503 are output as independent user interfaces, the first ring electronic device 10 may generate and output the first partial screen 15100 for a user interface corresponding to the content of the first ring electronic device 10 based on detecting at least a part of the second trigger motion and transmit a request signal for the unified projection screen to the second ring electronic device 20 and the third ring electronic device 30. The second ring electronic device 20 and the third ring electronic device 30 may generate and output the second partial screen 15200 and the third partial screen 15300, respectively, based on the request signal for the unified projection screen.

According to an embodiment, different parts of the unified projection screen 15000 for an expanded user interface corresponding to the same content may be output as the first partial screen 15100, the second partial screen 15200, and the third partial screen 15300. For example, the first partial screen 15100, the second partial screen 15200, and the third partial screen 15300 may form a unified interface.

For example, when a third trigger motion for expanding a user interface for the first partial screen 15100 is detected while the first partial screen 15100, the second partial screen 15200, and the third partial screen 15300 are output as independent user interfaces, a first part, a second part, and a third part of a screen for an expanded user interface corresponding to the first ring electronic device 10 may be output as the first partial screen 15100, the second partial screen 15200, and the third partial screen 15300, respectively.

For example, when the second trigger motion for the unified projection screen is detected while any ring electronic device outputs a projection screen for a user interface corresponding to a home screen (simply put, a projection screen displaying a home screen), a first part, a second part, and a third part of a screen for an expanded user interface corresponding to the content of another ring electronic device that executes any application may be output as the first partial screen 15100, the second partial screen 15200, and the third partial screen 15300, respectively. For example, a ring electronic device that does not execute any applications may be excluded when configuring the unified projection screen 15000.

For example, when the second trigger motion for the unified projection screen is detected while the first projection screen 1501, the second projection screen 1502, and the third projection screen 1503 are output as independent user interfaces, a first part, a second part, and a third part of a screen for an expanded user interface corresponding to the content of a main ring electronic device may be output as the first partial screen 15100, the second partial screen 15200, and the third partial screen 15300, respectively. That is, a ring electronic device (hereinafter, auxiliary ring electronic device) other than the main ring electronic device may be excluded when configuring the unified projection screen 15000. According to an embodiment, when the second trigger motion is detected while the auxiliary ring electronic device executes any application, the execution of the application may be stopped or the application may be executed in the background. One of the plurality of ring electronic devices may be set as the main ring electronic device. The main ring electronic device may be selected or changed by the user.

According to an embodiment, a first part, a second part, and a third part of a screen for an expanded user interface corresponding to the content of an external electronic device (e.g., the electronic device 101 of FIG. 1 or the external electronic device 50 of FIGS. 5b, 5c, or FIG. 13) connected to the first ring electronic device 10, the second ring electronic device 20, and the third ring electronic device 30 may be output as the first partial screen 15100, the second partial screen 15200, and the third partial screen 15300, respectively.

According to an embodiment, the description of the unified projection screen (e.g., the unified projection screen 6100 of FIG. 6 or the unified projection screen 7100 of FIG. 7) provided with reference to FIGS. 2 to 14 may apply to the unified projection screen 15000, so any redundant description related may not be repeated here.

According to an embodiment, the first ring electronic device 10 may generate and output a first part for a partial unified projection screen of the first ring electronic device 10 and the second ring electronic device 20 based on detecting at least a part of a third trigger motion for expanding user interfaces for the first partial screen 15100 and the second partial screen 15200 while the first partial screen 15100, the second partial screen 15200, and the third partial screen 15300 for the unified projection screen 15000 are output. For example, the partial unified projection screen may be output on an area where the first partial screen 15100 and the second partial screen 15200 are output. The second ring electronic device 20 may output the second part for the partial unified projection screen. The first ring electronic device 10 may generate and output the first part for the unified projection screen 15000 based on detecting at least a part of the third trigger motion for the partial unified projection screen and the third partial screen 15300. The second ring electronic device 20 may output the second part for the unified projection screen 15000. The third ring electronic device 30 may output the third part for the unified projection screen 15000. The descriptions of the various embodiments provided above regarding whether a screen for an expanded user interface is generated (or rendered), a rendering entity of an image signal forming the basis of each part, and the like may apply in the same way, so any redundant description related thereto may not be repeated here.

According to an embodiment, the first ring electronic device 10 may generate the first part, the second part, and the third part by splitting the screen for the expanded user interface corresponding to the content of the first ring electronic device 10, based on detecting at least a part of the third trigger motion for expanding the user interface for the first partial screen 15100 and the third partial screen 15300 while the first partial screen 15100, the second partial screen 15200, and the third partial screen 15300 for the unified projection screen 15000 are output. The first ring electronic device 10 may output the first part. The second ring electronic device 20 may output the second part of the screen for the expanded user interface. The third ring electronic device 30 may output the third part of the screen for the expanded user interface.

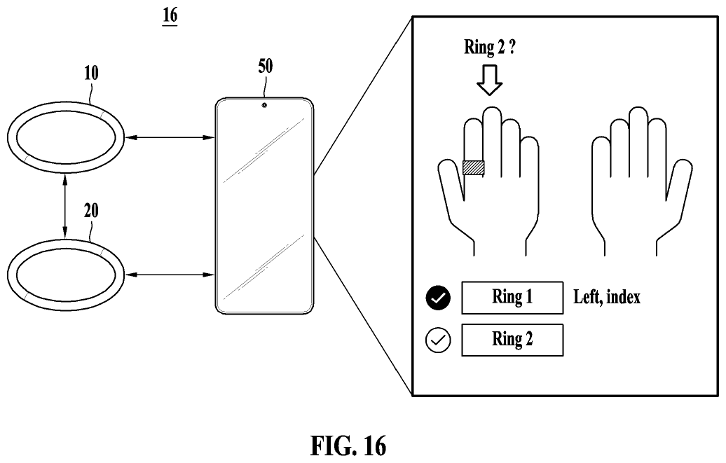

FIG. 16 is a diagram illustrating an example configuration of a system including a ring electronic device, according to various example embodiments.

According to an embodiment, a system 16 may include at least one of the first ring electronic device 10 (e.g., the electronic device 102 of FIG. 1 or the ring electronic device 200 of FIG. 2), the second ring electronic device 20 (e.g., the electronic device 102 of FIG. 1 or the ring electronic device 200 of FIG. 2), or the external electronic device 50 (e.g., the electronic device 101 of FIG. 1 or the external electronic device 50 of FIGS. 5B, 5C, or 13).

According to an embodiment, the system 16 may further include a third ring electronic device (e.g., the third ring electronic device 30 of FIG. 15). According to an embodiment, the system 16 may include various numbers of ring electronic devices. However, the disclosure is not limited thereto.

According to an embodiment, the system 16 may be implemented such that each of a plurality of ring electronic devices performs the operations, functions, and techniques described above.

According to an embodiment, it is described, with reference to FIGS. 2 to 15, that the first ring electronic device 10 may perform the operations, functions, and techniques described above.

According to an embodiment, the second ring electronic device 20 (or the third ring electronic device) may perform the operations, functions, and techniques described above with reference to FIGS. 2 to 15. In the descriptions provided with FIGS. 2 to 15, the same or similar objectives, functions, and effects may be achieved even if the first ring electronic device 10 is replaced with the second ring electronic device 20. For example, in example embodiments of the first ring electronic device 10 and the second ring electronic device 20, when the second ring electronic device 20 performs the operations of the first ring electronic device 10 described above, the second ring electronic device 20 may be replaced with the first ring electronic device 10 (or the third ring electronic device). According to an embodiment, at least some of the aforementioned operations may be appropriately modified if necessary.

According to an embodiment, the system 16 may be implemented to perform the aforementioned operations, functions, and techniques centered on a main ring electronic device among a plurality of ring electronic devices.

According to an embodiment, when the first ring electronic device 10 is the main ring electronic device, the first ring electronic device 10 may perform the aforementioned operations, functions, and techniques based on a variety of information (or data).

For example, the first ring electronic device 10 may receive, from the second ring electronic device 20 (and optionally, the third ring electronic device), information regarding a motion detected by the second ring electronic device 20. The first ring electronic device 10 may detect various motions (e.g., a second trigger motion for a unified projection screen) by comprehensively considering information regarding a motion detected by the first ring electronic device 10 and a motion detected by the second ring electronic device 20.

For example, the first ring electronic device 10 may receive, from the second ring electronic device 20, information regarding a screen (a second projection screen or a second partial screen) and content of the second ring electronic device 20.

For example, the first ring electronic device 10 may receive information regarding a task of the second ring electronic device 20 from the second ring electronic device 20.

For example, the first ring electronic device 10 may receive information such as the distance between the second ring electronic device 20 and a screen detected through a component of the second ring electronic device 200, the projection state of the screen, a screen of the first ring electronic device 10, the alignment state of the screens, and the amount of ambient light.

According to an embodiment, the first ring electronic device 10 may generate a request signal for a unified projection screen of the first ring electronic device 10 and the second ring electronic device 20 and transmit the request signal to the second ring electronic device 20.

According to an embodiment, the first ring electronic device 10 may generate a first part and a second part of a screen for an expanded user interface corresponding to the content of the first ring electronic device 10 and transmit the second part to the second ring electronic device 20.

According to an embodiment, the system 16 may be implemented to perform the aforementioned operations, functions, and techniques centered on the external electronic device 50 connected to a plurality of ring electronic devices.

According to an embodiment, the external electronic device 50 may generate a request signal for a unified projection screen of the first ring electronic device 10 and the second ring electronic device 20 and transmit the request signal to the first ring electronic device 10 and the second ring electronic device 20.

According to an embodiment, the external electronic device 50 may generate a first part and a second part of a screen for an expanded user interface corresponding to the content of the external electronic device 50 and transmit the first and second parts to the first ring electronic device 10 and the second ring electronic device 20.

According to an embodiment, the external electronic device 50 may receive information regarding a motion detected by the first ring electronic device 10 from the first ring electronic device 10 and receive information regarding a motion detected by the second ring electronic device 20 from the second ring electronic device 20. The external electronic device 50 may detect various motions (e.g., a second trigger motion for a unified projection screen) by comprehensively considering information regarding a motion detected by the first ring electronic device 10 and a motion detected by the second ring electronic device 20.

According to an embodiment, the external electronic device 50 may transmit the request signal for the unified projection screen to the first ring electronic device 10 and the second ring electronic device 20, based on detecting at least a part of the second trigger motion. According to an embodiment, the external electronic device 50 may generate each part of a screen for an expanded user interface corresponding to the content of the external electronic device 50 and transmit each part to the first ring electronic device 10 and the second ring electronic device 20. According to an embodiment, the external electronic device 50 may transmit the request signal for the unified projection screen to a main ring electronic device. For example, when the first ring electronic device 10 is the main ring electronic device, based on the request signal for the unified projection screen, the first ring electronic device 10 may generate and output the first part of the screen for the expanded user interface corresponding to the content of the first ring electronic device 10 and generate and transmit the second part to the second electronic device 20.

According to an embodiment, the system 16 may be implemented such that a plurality of ring electronic devices cooperate to perform some of the aforementioned operations, functions, and techniques. For example, the first ring electronic device 10 may receive, from the second ring electronic device 20, the information regarding the motion of the user detected by the second ring electronic device 20 and may control the projection circuitry to generate a screen (e.g., a first projection screen) based on the information regarding the motion of the user received from the second ring electronic device 20 and output the screen. The first ring electronic device 10 may generate the screen for the expanded user interface, generate the first part and the second part of the screen, and transmit the second part to the second ring electronic device 20. For example, some of the aforementioned functions may be performed by each ring electronic device, such as the first ring electronic device 10 generating a screen and the second ring electronic device 20 detecting a motion of the user.

According to an embodiment, the system 16 may be implemented such that the external electronic device 50 performs some of the aforementioned operations, functions, and techniques using the plurality of ring electronic devices. For example, the external electronic device 50 may receive, from the second ring electronic device 20, the information regarding the motion of the user detected by the second ring electronic device 20 and may control the first ring electronic device 10 to generate a screen (e.g., the first projection screen) based on the information regarding the motion of the user received from the second ring electronic device 20 and output the screen. The external electronic device 50 may generate the screen for the expanded user interface, generate the first part and the second part of the screen, and transmit the first part and the second part to the first ring electronic device 10. For example, some of the aforementioned functions, such as the external electronic device 50 generating a screen, the first ring electronic device 10 outputting a screen through a projection circuitry, and the second ring electronic device 20 detecting a motion of a user, may be performed by each of the external electronic device 50, the first ring electronic device 10, and the second ring electronic device 20.

According to an embodiment, the system 16 may be implemented so that one ring electronic device outputs two screens. For example, the first ring electronic device 10 may include two openings. That is, the first ring electronic device 10 may be implemented in a form that may be worn on two fingers. The first ring electronic device 10 may be implemented in a form in which two rings are connected in hardware, unlike as shown in the diagrams of the present disclosure. The first ring electronic device 10 may further include at least some components of the second ring electronic device 20. For example, the projection circuitry of the first ring electronic device 10 may include a first projection lens (e.g., the projection lens 15 of FIG. 4) and a second projection lens (e.g., the projection lens 15 of FIG. 4). Based on data received from the sensor circuitry, the first ring electronic device 10 may identify that the first ring electronic device 10 is worn on one finger of the user and on another finger other than that finger. While being worn on the two fingers of the user, the first ring electronic device 10 may control the projection circuitry to output a screen (e.g., the first projection screen) through the first projection lens and output a screen (e.g., the second projection screen) through the second projection lens.

According to an embodiment, the system 16 may be implemented such that the fingers on which respective ring electronic devices are worn are selected through the external electronic device 50. The external electronic device 50 may receive, from the first ring electronic device 10 and/or the second ring electronic device 20, information indicating that the first ring electronic device 10 and the second ring electronic device 20 are in a worn state. For example, referring to FIG. 16, the external electronic device 50 may display, through a display, a user interface that allows selecting which finger each ring electronic device is worn on. For example, the user may select a hand and a finger of the user on which each ring electronic device is worn. Based on a user input, the external electronic device 50 may transmit, to the first ring electronic device 10 and/or the second ring electronic device 20, data regarding which finger of the user each ring electronic device is worn on. Based on the data received from the external electronic device 50, the first ring electronic device 10 may identify that the first ring electronic device 10 is worn on a predetermined finger of the user. Based on the data received from the external electronic device 50, the first ring electronic device 10 may identify which finger of the user each of the first ring electronic device 10 and the second ring electronic device 20 is worn on.

According to an example embodiment, a first ring electronic device 102, 200, or 10 may include a camera 11, sensor circuitry, a projection circuitry, at least one processor 210 including processing circuitry, and memory 220 including one or more storage media storing instructions, wherein the instructions, when executed by the at least one processor 210 individually or collectively, may cause the first ring electronic device 102, 200, or 10 to, based on data received from the sensor circuitry, identify that the first ring electronic device 102, 200, or 10 is worn on a finger 4 of a user, control the projection circuitry to output a first projection screen 401, 601, or 1501 on a surface of the user while the first ring electronic device 102, 200, or 10 is worn on the finger 4 of the user, wherein the first projection screen 401, 601, or 1501 has a left side 91, a right side 92, a near side 93, and a far side 94, and based on a motion of the user detected while the first projection screen 401, 601, or 1501 is output, control the projection circuitry to adjust at least one of a length of at least one of the left side 91, the right side 92, the near side 93, or the far side 94, a position of the first projection screen 401, 601, or 1501, or a rotation angle of the first projection screen 401, 601, or 1501.

According to an example embodiment, the instructions, when executed by the at least one processor 210 individually or collectively, may cause the first ring electronic device 102, 200, or 10 to, based on detecting at least a part of a first trigger motion for a projection screen using data received from the camera 11 while the first ring electronic device 102, 200, or 10 is worn on the finger 4 of the user, control the projection circuitry to output the first projection screen 401, 601, or 1501.

According to an example embodiment, the instructions, when executed by the at least one processor 210 individually or collectively, may cause the first ring electronic device 102, 200, or 10 to receive information regarding an output state of a second projection screen 602 or 1502 from a second ring electronic device 102, 200, or 20 worn on another finger 5 that is different from the finger 4 on which the first ring electronic device 102, 200, or 10 is worn, wherein the second projection screen 602 or 1502 is output on the surface of the user by the second ring electronic device 102, 200, or 20, based on detecting at least a part of a second trigger motion for a unified projection screen 6100 or 7100 of the first ring electronic device 102, 200, or 10 and the second ring electronic device 102, 200, or 20 using data received from the camera 11 while the first projection screen 401, 601, or 1501 and the second projection screen 602 or 1502 are output, generate a first partial screen 6010 or 701 for the unified projection screen 6100 or 7100, transmit a request signal for the unified projection screen 6100 or 7100 to the second ring electronic device 102, 200, or 20, and control the projection circuitry to output the first partial screen 6010, 701, or 15100 for the unified projection screen 6100 or 7100 as the first projection screen 401, 601, or 1501, wherein a second partial screen 6020, 702, or 15200 for the unified projection screen 6100 or 7100 is output as the second projection screen 602 or 1502 by the second ring electronic device 102, 200, or 20 based on the request signal.

According to an example embodiment, the instructions, when executed by the at least one processor 210 individually or collectively, may cause the first ring electronic device 102, 200, or 10 to, based on detecting at least a part of a third trigger motion for expansion of a user interface using data received from the camera 11 while the first partial screen 6010, 701, or 15100 for the unified projection screen 6100 or 7100 is output, generate a screen for an expanded user interface corresponding to content of the first ring electronic device 102, 200, or 10, generate a first part and a second part, wherein the first part is a portion of the screen for the expanded user interface and the second part is another portion of the screen for the expanded user interface, and transmit information regarding the second part to the second ring electronic device 102, 200, or 20.

According to an example embodiment, the instructions, when executed by the at least one processor 210 individually or collectively, may cause the first ring electronic device 102, 200, or 10 to control the projection circuitry to output the first part of the screen for the expanded user interface as the first partial screen 6010, 701, or 15100, wherein the second part of the screen for the expanded user interface is output as the second partial screen 6020, 702, or 15200 by the second ring electronic device 102, 200, or 20 based on the information regarding the second part.

According to an example embodiment, the instructions, when executed by the at least one processor 210 individually or collectively, may cause the first ring electronic device 102, 200, or 10 to control the projection circuitry to, based on detecting at least a part of an alignment motion for the first projection screen 401, 601, or 1501 using data received from the camera 11 while the first projection screen 401, 601, or 1501 is output, adjust a length of the first projection screen 401, 601, or 1501 between the near side 93 and the far side 94 of the first projection screen 401, 601, or 1501 such that the far side 94 of the first projection screen 401, 601, or 1501 reaches an alignment line indicated by the alignment motion, adjust a position of the first projection screen 401, 601, or 1501 such that the far side 94 of the first projection screen 401, 601, or 1501 reaches the alignment line indicated by the alignment motion, and/or adjust a rotation angle of the first projection screen 401, 601, or 1501 such that the far side 94 of the first projection screen 401, 601, or 1501 is parallel to the alignment line indicated by the alignment motion.

According to an example embodiment, the instructions, when executed by the at least one processor 210 individually or collectively, may cause the first ring electronic device 102, 200, or 10 to, based on detecting at least a part of an adjustment motion for the first projection screen 401, 601, or 1501 using data received from the camera 11 while the first projection screen 401, 601, or 1501 is output, activate an adjustment state of the first projection screen 401, 601, or 1501 and based on a motion of the user detected while the adjustment state is activated, control the projection circuitry to adjust the position of the first projection screen 401, 601, or 1501.

According to an example embodiment, the instructions, when executed by the at least one processor 210 individually or collectively, may cause the first ring electronic device 102, 200, or 10 to, based on detecting at least a part of an adjustment motion for the first projection screen 401, 601, or 1501 using data received from the camera 11 while the first projection screen 401, 601, or 1501 is output, activate an adjustment state of the first projection screen 401, 601, or 1501 and based on a motion of the user detected while the adjustment state is activated, control the projection circuitry to adjust the rotation angle of the first projection screen 401, 601, or 1501.

According to an example embodiment, the instructions, when executed by the at least one processor 210 individually or collectively, may cause the first ring electronic device 102, 200, or 10 to, based on detecting at least a part of a shut-down motion for the first projection screen 401, 601, or 1501 using data received from the camera 11 while the first projection screen 401, 601, or 1501 is output, control the projection circuitry to stop outputting the first projection screen 401, 601, or 1501.

According to an example embodiment, the instructions, when executed by the at least one processor 210 individually or collectively, may cause the first ring electronic device 102, 200, or 10 to, in response to receiving, from an external electronic device 50 connected to the first ring electronic device 102, 200, or 10, a state indicating that the external electronic device 50 is picked up while the first projection screen 401, 601, or 1501 is output, transmit information regarding the first projection screen 401, 601, or 1501 to the external electronic device 50.

According to an example embodiment, the instructions, when executed by the at least one processor 210 individually or collectively, may cause the first ring electronic device 102, 200, or 10 to, in response to receiving, from the external electronic device 50, a state indicating that the external electronic device 50 is picked up, control the projection circuitry to stop outputting the first projection screen 401, 601, or 1501.

According to an example embodiment, the instructions, when executed by the at least one processor 210 individually or collectively, may cause the first ring electronic device 102, 200, or 10 to detect an occurrence of a task associated with the first ring electronic device 102, 200, or 10 and based on detecting at least a part of the first trigger motion, control the projection circuitry to output the first projection screen 401, 601, or 1501 for a user interface corresponding to the task.

According to an example embodiment, the instructions, when executed by the at least one processor 210 individually or collectively, may cause the first ring electronic device 102, 200, or 10 to, based on detecting at least a part of a tap motion for the first projection screen 401, 601, or 1501 while the first projection screen 401, 601, or 1501 is output, generate a first changed projection screen 402 for a user interface that is changed in response to the tap motion and control the projection circuitry to output the first changed projection screen 402 as the first projection screen 401, 601, or 1501.

According to an example embodiment, the instructions, when executed by the at least one processor 210 individually or collectively, may cause the first ring electronic device 102, 200, or 10 to receive, from the external electronic device 50 connected to the first ring electronic device 102, 200, or 10, information regarding the first projection screen 401, 601, or 1501 corresponding to content of the external electronic device 50 and based on the information regarding the first projection screen 401, 601, or 1501, control the projection circuitry to output the first projection screen 401, 601, or 1501.

According to an example embodiment, the instructions, when executed by the at least one processor 210 individually or collectively, may cause the first ring electronic device 102, 200, or 10 to control the projection circuitry to stop outputting the first projection screen 401, 601, or 1501 when a predetermined state condition is satisfied while the first projection screen 401, 601, or 1501 is output.

According to an example embodiment, the instructions, when executed by the at least one processor 210 individually or collectively, may cause the first ring electronic device 102, 200, or 10 to receive information regarding a motion of the user detected by the second ring electronic device 102, 200, or 20 from the second ring electronic device 102, 200, or 20 worn on another finger 5 that is different from the finger 4 on which the first ring electronic device 102, 200, or 10 is worn and based on the information regarding the motion of the user received from the second ring electronic device 102, 200, or 20, generate the first partial screen 6010 or 701 and the second partial screen 6020, 702, or 15200 for the unified projection screen 6100 or 7100 of the first ring electronic device 102, 200, or 10 and the second ring electronic device 102, 200, or 20.

According to an example embodiment, the instructions, when executed by the at least one processor 210 individually or collectively, may cause the first ring electronic device 102, 200, or 10 to identify that the first ring electronic device 102, 200, or 10 is worn on another finger 5 that is different from the finger 4 of the user using data received from the sensor circuitry, wherein the first ring electronic device 102, 200, or 10 includes two openings, output the first projection screen 501, 601, or 1501 through a first projection lens while the first ring electronic device 102, 200, or 10 is worn on the finger 4 of the user and another finger 5, and control the projection circuitry to output the second projection screen 602 or 1502 through a second projection lens.

According to an example embodiment, the instructions, when executed by the at least one processor 210 individually or collectively, may cause the first ring electronic device 102, 200, or 10 to identify that the first ring electronic device 102, 200, or 10 is worn on the finger 4 of the user based on data received from the external electronic device 50 connected to the first ring electronic device 102, 200, or 10.

According to an example embodiment, a first ring electronic device 102, 200, or 10 includes a camera 11, sensor circuitry, a projection circuitry, at least one processor 210 including processing circuitry, and memory 220 including one or more storage media storing instructions, wherein the instructions, when executed by the at least one processor 210 individually or collectively, may cause the first ring electronic device 102, 200, or 10 to, based on data received from the sensor circuitry, identify that the first ring electronic device 102, 200, or 10 is worn on a finger 4 of a user, control the projection circuitry to output a first projection screen 401, 601, or 1501 on a surface of the user while the first ring electronic device 102, 200, or 10 is worn on the finger 4 of the user based on detecting at least a part of a first trigger motion for the projection screen using the data received from the camera 11, wherein the first projection screen 401, 601, or 1501 has a left side 91, a right side 92, a near side 93, and a far side 94, wherein a second projection screen 602 or 1502 is output on a surface of the user by the second ring electronic device 102, 200, or 20 worn on another finger 5 that is different from the finger 4 of the user, and while the first projection screen 401, 601, or 1501 and the second projection screen 602 or 1502 are output, based on detecting at least a part of a second trigger motion for a unified projection screen 6100 or 7100 of the first ring electronic device 102, 200, or 10 and the second ring electronic device 102, 200, or 20 and at least a part of a third trigger motion for expanding a user interface using the data received from the camera 11, control the projection circuitry to output a first part as the projection screen 401, 601, or 1501, wherein the first part is a part of a screen for an expanded user interface corresponding to content of the first ring electronic device 102, 200, or 10 or content of the external electronic device connected to the first ring electronic device 102, 200, or 10.

According to an example embodiment, a method performed by a first ring electronic device 102, 200, or 10, wherein the first ring electronic device 102, 200, or 10 may include a camera 11, sensor circuitry, a projection circuitry, at least one processor 210 including processing circuitry, and memory 220 including one or more storage media storing instructions, and the instructions, when executed by the at least one processor 210 individually or collectively, may cause the first ring electronic device 102, 200, or 10 to, based on data received from the sensor circuitry, identify that the first ring electronic device 102, 200, or 10 is worn on a finger 4 of a user, control the projection circuitry to output a first projection screen 401, 601, or 1501 on a surface of the user while the first ring electronic device 102, 200, or 10 is worn on the finger 4 of the user, wherein the first projection screen 401, 601, or 1501 has a left side 91, a right side 92, a near side 93, and a far side 94, and based on a motion of the user detected while the first projection screen 401, 601, or 1501 is output, control the projection circuitry to adjust at least one of a length of at least one of the left side 91, the right side 92, the near side 93, or the far side 94, a position of the first projection screen 401, 601, or 1501, or a rotation angle of the first projection screen 401, 601, or 1501.

According to an example embodiment, a non-transitory computer-readable storage medium storing one or more programs including instructions, wherein the instructions, when executed by at least one processor 210 of a first ring electronic device 102, 200, or 10 individually or collectively, may cause the first ring electronic device 102, 200, or 10 to, based on data received from sensor circuitry, identify that the first ring electronic device 102, 200, or 10 is worn on a finger 4 of a user, control a projection circuitry to output a first projection screen 401, 601, or 1501 on a surface of the user while the first ring electronic device 102, 200, or 10 is worn on the finger 4 of the user, wherein the first projection screen 401, 601, or 1501 has a left side 91, a right side 92, a near side 93, and a far side 94, and based on a motion of the user detected while the first projection screen 401, 601, or 1501 is output, control the projection circuitry to adjust at least one of a length of at least one of the left side 91, the right side 92, the near side 93, or the far side 94, a position of the first projection screen 401, 601, or 1501, or a rotation angle of the first projection screen 401, 601, or 1501.

The various example embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. A processing device may run an OS and a software application that runs on the OS. The processing device may also access, store, manipulate, process, and generate data in response to execution of software. For purpose of simplicity, the description of a processing device is used as singular; however, one skilled in the art will appreciate that a processing device may include a plurality of processing elements and/or a plurality of types of processing elements. For example, the processing device may include a plurality of processors or a single processor and a single controller. In addition, different processing configurations are possible, such as parallel processors.

Software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a computer-readable storage medium.

The method according to various embodiments described herein may be recorded in computer-readable media including program instructions to implement various operations of various embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape, optical media such as compact disc read-only memory (CD-ROM) discs and digital video discs (DVDs), magneto-optical media such as floptical disks, and hardware devices that are specifically configured to store and perform program instructions, such as ROM, random-access memory (RAM), flash memory, and the like. Examples of program instructions include both machine code, such as code produced by a compiler, and files including higher level code that may be executed by a computer using an interpreter.

The hardware devices described above may be configured to act as one or more software modules in order to perform the operations of various embodiments described above, or vice versa.

As described above, although the various example embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuitry are combined in a different manner, or replaced or supplemented by other components or their equivalents.

Therefore, other implementations, other embodiments, and equivalents to the claims are also within the scope of the disclosure, including the following claims.

What is claimed is:

1. A first ring electronic device comprising:
a camera;
sensor circuitry;
projection circuitry;
at least one processor comprising processing circuitry; and
memory comprising one or more storage media storing instructions, wherein the instructions, when executed by at least one processor, individually or in any combination, cause the first ring electronic device to:
based on data received from the sensor circuitry, identify that the first ring electronic device is worn on a finger of a user;
control the projection circuitry to output a first projection screen on a surface of the user while the first ring electronic device is worn on the finger of the user, wherein the first projection screen has a left side, a right side, a near side, and a far side; and
based on a motion of the user detected while the first projection screen is output, control the projection circuitry to adjust at least one of a length of at least one of the left side, the right side, the near side, and/or the far side, a position of the first projection screen, and/or a rotation angle of the first projection screen.

2. The first ring electronic device of claim 1, wherein the instructions, when executed by at least one processor, individually or in any combination, cause the first ring electronic device to: based on detecting at least a part of a first trigger motion for a projection screen using data received from the camera while the first ring electronic device is worn on the finger of the user, control the projection circuitry to output the first projection screen.

3. The first ring electronic device of claim 1, wherein the instructions, when executed by at least one processor, individually or in any combination, cause the first ring electronic device to:
receive information regarding an output state of a second projection screen from a second ring electronic device worn on another finger different from the finger on which the first ring electronic device is worn, wherein the second ring is configured to output the second projection screen on the surface of the user;
based on detecting at least a part of a second trigger motion for a unified projection screen of the first ring electronic device and the second ring electronic device using data received from the camera while the first projection screen and the second projection screen are output, generate a first partial screen for the unified projection screen, transmit a request signal for the unified projection screen to the second ring electronic device; and
control the projection circuitry to output the first partial screen for the unified projection screen as the first projection screen, wherein a second partial screen for the unified projection screen is output as the second projection screen by the second ring electronic device based on the request signal.

4. The first ring electronic device of claim 3, wherein the instructions, when executed by at least one processor, individually or in any combination, cause the first ring electronic device to:
based on detecting at least a part of a third trigger motion for expansion of a user interface using data received from the camera while the first partial screen for the unified projection screen is output, generate a screen for an expanded user interface corresponding to content of the first ring electronic device;
generate a first part and a second part, wherein the first part is a portion of the screen for the expanded user interface and the second part is another portion of the screen for the expanded user interface;
transmit information regarding the second part to the second ring electronic device; and
control the projection circuitry to output the first part of the screen for the expanded user interface as the first partial screen, wherein the second part of the screen for the expanded user interface is output as the second partial screen by the second ring electronic device based on the information regarding the second part.

5. The first ring electronic device of claim 1, wherein the instructions, when executed by at least one processor, individually or in any combination, cause the first ring electronic device to control the projection circuitry to:
based on detecting at least a part of an alignment motion for the first projection screen using data received from the camera while the first projection screen is output,
adjust a length of the first projection screen between the near side and the far side of the first projection screen such that the far side of the first projection screen reaches an alignment line indicated by the alignment motion;
adjust a position of the first projection screen such that the far side of the first projection screen reaches the alignment line indicated by the alignment motion; and/or adjust a rotation angle of the first projection screen such that the far side of the first projection screen is parallel to the alignment line indicated by the alignment motion.

6. The first ring electronic device of claim 1, wherein the instructions, when executed by at least one processor, individually or in any combination, cause the first ring electronic device to:
based on detecting at least a part of an adjustment motion for the first projection screen using data received from the camera while the first projection screen is output, activate an adjustment state of the first projection screen; and
based on a motion of the user detected while the adjustment state is activated, control the projection circuitry to adjust the position of the first projection screen.

7. The first ring electronic device of claim 1, wherein the instructions, when executed by at least one processor, individually or in any combination, cause the first ring electronic device to:
based on detecting at least a part of an adjustment motion for the first projection screen using data received from the camera while the first projection screen is output, activate an adjustment state of the first projection screen; and
based on a motion of the user detected while the adjustment state is activated, control the projection circuitry to adjust the rotation angle of the first projection screen.

8. The first ring electronic device of claim 1, wherein the instructions, when executed by at least one processor, individually or in any combination, cause the first ring electronic device to:
based on detecting at least a part of a shut-down motion for the first projection screen using data received from the camera while the first projection screen is output, control the projection circuitry to stop outputting the first projection screen.

9. The first ring electronic device of claim 1, wherein the instructions, when executed by at least one processor, individually or in any combination, cause the first ring electronic device to:
in response to receiving, from an external electronic device connected to the first ring electronic device, a state indicating that the external electronic device is picked up while the first projection screen is output, transmit information regarding the first projection screen to the external electronic device.

10. The first ring electronic device of claim 9, wherein the instructions, when executed by at least one processor, individually or in any combination, cause the first ring electronic device to:
in response to receiving, from the external electronic device, a state indicating that the external electronic device is picked up, control the projection circuitry to stop outputting the first projection screen.

11. The first ring electronic device of claim 2, wherein the instructions, when executed by at least one processor, individually or in any combination, cause the first ring electronic device to:
detect an occurrence of a task associated with the first ring electronic device; and
based on detecting at least a part of the first trigger motion, control the projection circuitry to output the first projection screen for a user interface corresponding to the task.

12. The first ring electronic device of claim 1, wherein the instructions, when executed by at least one processor, individually or in any combination, cause the first ring electronic device to:
based on detecting at least a part of a tap motion for the first projection screen while the first projection screen is output, generate a first changed projection screen for a user interface changed in response to the tap motion; and
control the projection circuitry to output the first changed projection screen as the first projection screen.

13. The first ring electronic device of claim 1, wherein the instructions, when executed by at least one processor, individually or in any combination, cause the first ring electronic device to:
receive, from the external electronic device connected to the first ring electronic device, information regarding the first projection screen corresponding to content of the external electronic device; and
based on the information regarding the first projection screen, control the projection circuitry to output the first projection screen.

14. A method performed by a first ring electronic device, wherein the first ring electronic device comprises:
a camera;
sensor circuitry;
a projection circuitry;
at least one processor comprising processing circuitry; and
memory comprising one or more storage media storing instructions, and the instructions, when executed by at least one processor, individually or in any combination, cause the first ring electronic device to perform the method comprising:
based on data received from the sensor circuitry, identify that the first ring electronic device is worn on a finger of a user;
control the projection circuitry to output a first projection screen on a surface of the user while the first ring electronic device is worn on the finger of the user, wherein the first projection screen has a left side, a right side, a near side, and a far side; and
based on a motion of the user detected while the first projection screen is output, control the projection circuitry to adjust at least one of a length of at least one of the left side, the right side, the near side, and/or the far side, a position of the first projection screen, and/or a rotation angle of the first projection screen.

15. A non-transitory computer-readable storage medium storing one or more programs comprising instructions,
wherein the instructions, when executed by at least one processor, comprising processing circuitry, of a first ring electronic device, individually or in any combination, cause the first ring electronic device to perform operations comprising:
based on data received from sensor circuitry, identify that the first ring electronic device is worn on a finger of a user;
control projection circuitry to output a first projection screen on a surface of the user while the first ring electronic device is worn on the finger of the user, wherein the first projection screen has a left side, a right side, a near side, and a far side; and
based on a motion of the user detected while the first projection screen is output, control the projection circuitry to adjust at least one of a length of at least one of the left side, the right side, the near side, and/or the far side, a position of the first projection screen, and/or a rotation angle of the first projection screen.
